(19) United States
(12) Patent Application Publication
(10) Pub. No.: US 2026/0036468 A1
(43) Pub. Date: Feb. 5, 2026

(54) METHOD FOR CALIBRATING ILLUMINANCE SENSOR AND ELECTRONIC DEVICE SUPPORTING SAME

(71) Applicant: SAMSUNG ELECTRONICS CO., LTD., Suwon-si (KR)

(72) Inventors: Jongah KIM, Suwon-si (KR); Kyusung KIM, Suwon-si (KR); Heewoong YOON, Suwon-si (KR); Kihyuk LEE, Suwon-si (KR); Donghan LEE, Suwon-si (KR); Gwangho CHOI, Suwon-si (KR)

(73) Assignee: SAMSUNG ELECTRONICS CO., LTD., Suwon-si (KR)

(21) Appl. No.: 19/352,619

(22) Filed: Oct. 8, 2025

Related U.S. Application Data
(63) Continuation of application No. PCT/KR2024/003712, filed on Mar. 25, 2024.

(30) Foreign Application Priority Data
Apr. 13, 2023 (KR) 10-2023-0049011
May 24, 2023 (KR) 10-2023-0067062

(51) Int. Cl. G01J 3/50; G01J 3/02

(52) U.S. Cl. CPC G01J 3/506; G01J 3/0297

(57) ABSTRACT

An electronic device may include: a display, a light sensor, and at least one processor configured to obtain a first illuminance value based on illuminance data obtained through the light sensor for a first time during which the display is turned on and off, obtain a second illuminance value based on illuminance data obtained through the light sensor for a second time shorter than the first time, while the display is turned on and off, determine a third illuminance value based on the first illuminance value and the second illuminance value, determine a fourth illuminance value based on color information about an image displayed through the display and information related to a luminance of the display, and determine a correction value for correcting an illuminance value obtained through the light sensor based on the third illuminance value and the fourth illuminance value.

### CROSS-REFERENCE TO RELATED APPLICATION

This application is a bypass continuation application of International Patent Application No. PCT/KR2024/003712, filed on Mar. 25, 2024, which claims priority to Korean Patent Application No. 10-2023-0049011, filed on Apr. 13, 2023, and Korean Patent Application No. 10-2023-0067062, filed on May 24, 2023, in the Korean Intellectual Property Office, the disclosures of which are incorporated herein by reference in their entireties.

### BACKGROUND

The disclosure relates to a method for calibrating an illuminance sensor and an electronic device supporting the same.

An electronic device may measure an illuminance (e.g., an illuminance value of external light) of the environment in which the electronic device is positioned through an illuminance sensor. The electronic device may adjust the luminance of the display based on the illuminance measured through the illuminance sensor.

The illuminance sensor may be disposed under the display (e.g., the rear surface of the display) when viewed from the front surface (e.g., the surface where the display of the electronic device is exposed) of the electronic device. As a result, the illuminance value measured by the illuminance sensor may include, in addition to the illuminance value affected by the external light incident from the outside of the electronic device (hereinafter referred to as “external light”), the light emitted from the display (hereinafter referred to as “display light”). Accordingly, the electronic device may obtain (e.g., calculate) the illuminance value affected by the external light incident from outside the electronic device by subtracting the illuminance value affected by the display light from the illuminance value measured through the illuminance sensor.

The above-described information may be provided as related art for the purpose of helping understanding of the disclosure. No claim or determination is made as to whether any of the foregoing is applicable as background art in relation to the disclosure.

### SUMMARY

The illuminance value (or the illuminance value affected by light emitted from the display) measured through the illuminance sensor may vary according to the display and/or the illuminance sensor. For example, there may be a deviation in transmittance between the displays (e.g., the proportions where each of the displays transmits light) (e.g., about +50% deviation with respect to the transmittance corresponding to the average or median value), and a deviation between the characteristics of the illuminance sensors (e.g., about +10% deviation with respect to the characteristic value corresponding to the average or median value). Due to the deviations, in the combinations (or sets) of the displays and the illuminance sensors, a deviation may occur between illuminance values measured through the illuminance sensors.

In order to correct (or also referred to as “compensation”) the deviation between the illuminance values, calibration for the illuminance sensor may be performed in the step of mounting the display and the illuminance sensor on the electronic device (hereinafter referred to as a “process step”). The calibration for the illuminance sensor may include an operation of calculating a correction value (also referred to as a “correction coefficient” or “correction information”) for calculating the illuminance value affected by external light from the illuminance value measured through the illuminance sensor.

In the process step, the calibration for the illuminance sensor may be performed on each of the combinations between the plurality of displays and the plurality of illuminance sensors in a darkroom condition (also referred to as a “darkroom environment”) in which external light is blocked. For example, with each of the combinations between the plurality of displays and the plurality of illuminance sensors disposed in a darkroom jig (e.g., box-type equipment that may create the darkroom condition), calibration may be performed on each of the combinations between the plurality of displays and the plurality of illuminance sensors. In each of the combinations between the plurality of displays and the plurality of illuminance sensors in the darkroom condition, a plurality of illuminance values corresponding to the combinations between the plurality of displays and the plurality of illuminance sensors may be measured by measuring the illuminance value of the display light through the illuminance sensor while the display displays a white image having the maximum brightness at the maximum luminance. By dividing the average value of the plurality of illuminance values by an illuminance value corresponding to the individual combination of the display and the illuminance sensor, a correction coefficient may be calculated in the individual combination of the display and the illuminance sensor.

Further, like the calibration for the illuminance sensor in the process step, replacing a display or illuminance sensor in an electronic device including the display and the illuminance sensor inconveniently requires that calibration be performed on the illuminance sensor after creating a darkroom condition using a darkroom jig when replacing the display or illuminance sensor, resulting in an increase in costs.

An embodiment of the disclosure relates to a method for calibrating an illuminance sensor and an electronic device supporting the same, which may perform calibration on an illuminance sensor while excluding an illuminance value that may be affected by the external light, similarly to calibration on the illuminance sensor performed in the darkroom condition, while the user is using the electronic device after the display or illuminance sensor included in the electronic device is replaced.

The objects of the disclosure are not limited to the foregoing, and other objects not mentioned will be apparent to those of ordinary skill in the art to which the disclosure pertains from the following descriptions.

According to an aspect of the present disclosure, an electronic device may include: a display; a light sensor; at least one processor; and memory storing instructions that, when executed by the at least one processor, cause the electronic device to: obtain a first illuminance value based on illuminance data obtained through the light sensor for a first time during which the display is turned on and off, obtain a second illuminance value based on illuminance data obtained through the light sensor for a second time shorter than the first time, while the display is turned on and off, determine a third illuminance value based on the first illuminance value and the second illuminance value, determine a fourth illuminance value based on color information about an image displayed through the display and display luminance information related to the display, and determine a correction value for correcting an illuminance value obtained through the light sensor based on the third illuminance value and the fourth illuminance value.

According to an aspect of the present disclosure, a method for calibrating a light sensor in an electronic device, may include: obtaining a first illuminance value based on illuminance data obtained through the light sensor for a first time during which a display of the electronic device is turned on and off; obtaining a second illuminance value based on illuminance data obtained through the light sensor for a second time shorter than the first time, while the display is turned on and off; determining a third illuminance value based on the first illuminance value and the second illuminance value; determining a fourth illuminance value based on color information about an image displayed through the display and display luminance information related to the display; and determining a correction value for correcting an illuminance value obtained through the light sensor based on the third illuminance value and the fourth illuminance value.

According to an aspect of the present disclosure, a non-transitory computer-readable medium storing computer-executable instructions, when executed by at least one processor of an electronic device, causing the electronic device to: obtain a first illuminance value based on illuminance data obtained through a light sensor of the electronic device for a first time during which a display of the electronic device is turned on and off; obtain a second illuminance value based on illuminance data obtained through the light sensor for a second time shorter than the first time, while the display is turned on and off, determine a third illuminance value based on the first illuminance value and the second illuminance value, determine a fourth illuminance value based on color information about an image displayed through the display and display luminance information related to the display, and determine a correction value for correcting an illuminance value obtained through the light sensor based on the third illuminance value and the fourth illuminance value.

### BRIEF DESCRIPTION OF DRAWINGS

FIG. 1 is a block diagram illustrating an electronic device in a network environment according to an embodiment;

FIG. 2 is a block diagram illustrating a display module according to an embodiment;

FIG. 3 is a view illustrating an electronic device according to an embodiment;

FIG. 4 is a cross-sectional view illustrating an electronic device according to an embodiment;

FIG. 5 is a block diagram illustrating an electronic device according to an embodiment;

FIG. 6 is a flowchart illustrating a method for calibrating an illuminance sensor, according to an embodiment;

FIG. 7 is a view illustrating a method for calibrating an illuminance sensor, according to an embodiment;

FIG. 8 is a view illustrating a method for calibrating an illuminance sensor, according to an embodiment;

FIG. 9 is a flowchart illustrating a method for calibrating an illuminance sensor, according to an embodiment;

FIG. 10 is a view illustrating a method for calibrating an illuminance sensor, according to an embodiment;

FIG. 11 is a view illustrating a method for calibrating an illuminance sensor, according to an embodiment;

FIG. 12 is a flowchart illustrating a method for calibrating an illuminance sensor, according to an embodiment;

FIG. 13 is a view illustrating a method for calibrating an illuminance sensor, according to an embodiment;

FIG. 14 is a flowchart illustrating a method for calibrating an illuminance sensor, according to an embodiment;

FIG. 15 is a view illustrating an illuminance value obtained by an illuminance sensor when a light source is a flicker light source, according to an embodiment;

FIG. 16 is a view illustrating an illuminance value obtained by an illuminance sensor when a light source is a light source having a form in which the intensity of light varies, according to an embodiment;

FIG. 17 is a view illustrating an illuminance value obtained by an illuminance sensor when an illuminance sensor is obscured by an object, according to an embodiment;

FIG. 18 is a flowchart illustrating a method for calibrating an illuminance sensor, according to an embodiment;

FIG. 19 is a flowchart illustrating a method for calibrating an illuminance sensor, according to an embodiment;

FIG. 20 is a flowchart illustrating a method for calibrating an illuminance sensor, according to an embodiment; and

FIG. 21 is a flowchart illustrating a method for calibrating an illuminance sensor, according to an embodiment.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

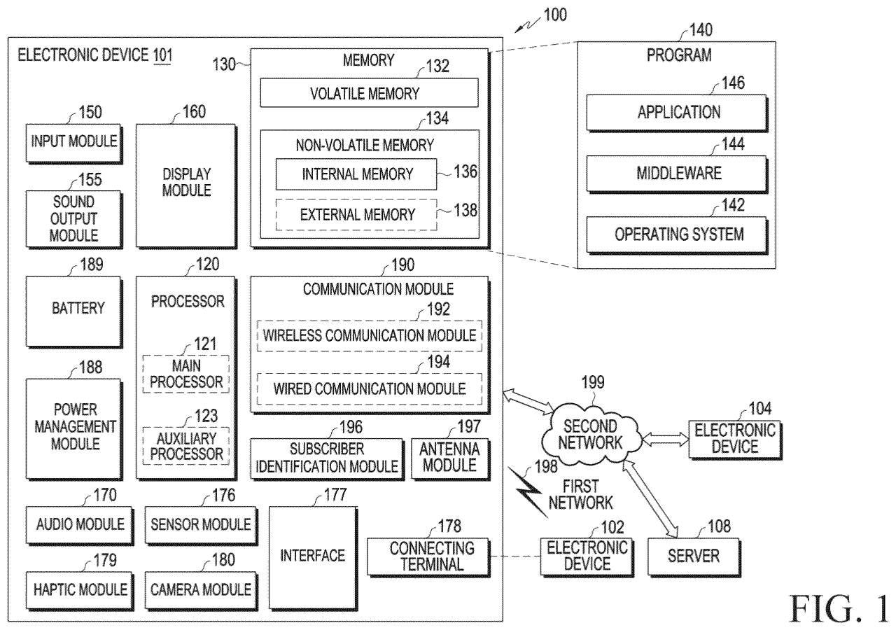

FIG. 1 is a block diagram illustrating an electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

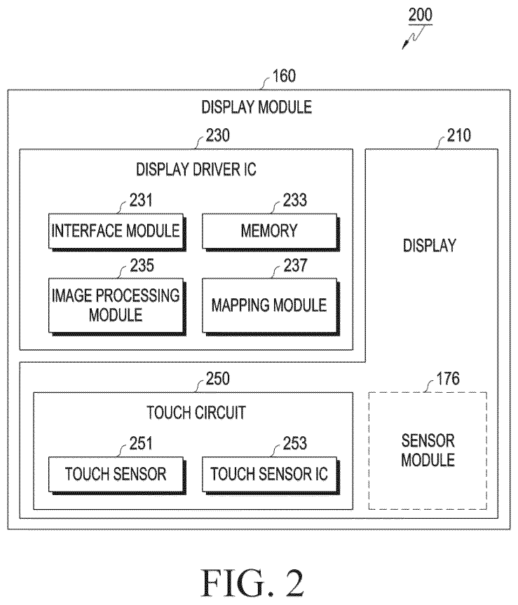

FIG. 2 is a block diagram 200 illustrating a display module 160 according to an embodiment.

Referring to FIG. 2, the display module 160 may include a display 210 and a display driver integrated circuit (DDI) 230 to control the display 110. The DDI 230 may include an interface module 231, memory 233 (e.g., buffer memory), an image processing module 235, or a mapping module 237. The DDI 230 may receive image information that contains image data or an image control signal corresponding to a command to control the image data from another component of the electronic device 101 via the interface module 231. For example, image information may be received from a processor (e.g., the processor 120 of FIG. 1 (e.g., the main processor 121 of FIG. 1) (e.g., an application processor)) or an auxiliary processor (e.g., the auxiliary processor 123 of FIG. 1 (e.g., a graphic processing device)) operated independently from the function of the main processor. The DDI 230 may communicate, for example, with touch circuitry 250 or the sensor module 176 via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 210. The mapping module 237 may generate a voltage value or a current value corresponding to the image data pre-processed or post-processed by the image processing module 135. According to an embodiment, the generating of the voltage value or current value may be performed, for example, based at least in part on one or more attributes of the pixels (e.g., an array, such as an RGB stripe or a pentile structure, of the pixels, or the size of each subpixel) of the display 210. At least some pixels of the display 210 may be driven, for example, based at least in part on the voltage value or the current value such that visual information (e.g., a text, an image, or an icon) corresponding to the image data may be displayed via the display 210.

According to an embodiment, the display module 160 may further include the touch circuitry 250. The touch circuitry 250 may include a touch sensor 251 and a touch sensor IC 253 to control the touch sensor 151. The touch sensor IC 253 may control the touch sensor 251 to sense a touch input or a hovering input with respect to a certain position on the display 210. To achieve this, for example, the touch sensor IC 253 may detect (e.g., measure) a change in a signal (e.g., a voltage, a quantity of light, a resistance, or a quantity of one or more electric charges) corresponding to the certain position on the display 210. The touch sensor IC 253 may provide input information (e.g., a position, an area, a pressure, or a time) indicative of the touch input or the hovering input detected to the processor 120. According to an embodiment, at least part (e.g., the touch sensor IC 253) of the touch circuitry 250 may be formed as part of the display 210 or the DDI 230, or as part of another component (e.g., the auxiliary processor 123) disposed outside the display module 160.

According to an embodiment, the display module 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 210, the DDI 230, or the touch circuitry 250)) of the display module 160. For example, when the sensor module 176 embedded in the display module 160 includes a biometric sensor (e.g., a fingerprint sensor), the biometric sensor may obtain biometric information (e.g., a fingerprint image) corresponding to a touch input received via a portion of the display 210. As another example, when the sensor module 176 embedded in the display module 160 includes a pressure sensor, the pressure sensor may obtain pressure information corresponding to a touch input received via a partial or whole area of the display 210. According to an embodiment, the touch sensor 251 or the sensor module 176 may be disposed between pixels in a pixel layer of the display 210, or over or under the pixel layer.

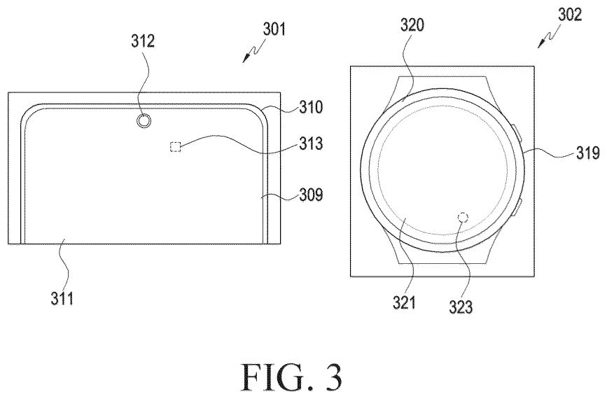

FIG. 3 is a view illustrating an electronic device 310, 320 according to an embodiment.

Referring to FIG. 3, according to an embodiment, the electronic device 310, 320 may be various types of electronic devices. For example, the electronic device 310, 320 may be a portable communication device (e.g., a smartphone) as illustrated in reference numeral 301 or a wearable device (e.g., a wearable watch) as illustrated in reference numeral 302. However, the form of the electronic device 310, 320 is not limited to the portable communication device and the wearable device.

In an embodiment, the electronic device 310, 320 may include a housing 309, 319, a display 311, 321, a camera 312, and/or an illuminance sensor 313, 323.

In an embodiment, the housing 309, 319 may include a front surface of the electronic device 310, 320 and a rear surface facing a rear surface in a direction opposite to the front surface. In an embodiment, the display 311, 321, the cameras 312, and/or the illuminance sensor 313, 323 may be disposed in the housing 309, 319.

In an embodiment, the display 311, 321 may be viewed through a portion of the front surface of the housing 309, 319. In an embodiment, the display 311, 321 may be various types of displays, such as a liquid crystal display (LCD) including a backlight, an organic light emitting diode (OLED) display in which each pixel emits light individually, or a quantum dot emitting diode (QLED) display.

In an embodiment, the camera 312 may obtain an image. In an embodiment, the camera 312 forms a notch, a U-shaped hole, a V-shaped hole, or an O-shaped hole in a portion of the housing 309, 319 (or a portion of the display 311, 321), and may be exposed to the outside through the formed notch or hole. However, the disclosure is not limited thereto, and the camera 312 may be an under display camera (UDC) disposed under the display 311, 321.

In an embodiment, the illuminance sensor 313, 323 may be disposed to overlap at least a partial area of the display 311, 321 when viewing the front surface of the housing 309, 319. For example, the illuminance sensor 313, 323 may be mounted on the rear surface of at least a partial area of the display 311, 321. For example, the illuminance sensor 313, 323 may be disposed between the display 311, 321 and the rear surface of the housing 309, 319.

In an embodiment, the illuminance sensor 313, 323 may include a sensor using the intensity of light incident from the outside, such as a visible light sensor, a proximity illuminance sensor (also referred to as a “proximity light sensor”), a spectrometer sensor, an ultraviolet sensor, or a color sensor. In an embodiment, the illuminance sensor 313, 323 may include a light receiving element such as a photodiode capable of receiving light incident from the outside.

In an embodiment, the illuminance sensor 313, 323 may be affected when measuring illuminance by the transmittance of external light by the display 311, 321 and/or the screen displayed on the display 311, 321. For example, when the display 311, 321 is an OLED display or QLED display in which each pixel emits individually, the illuminance value measured by the illuminance sensor 313, 323 may increase by the light emitted from the pixel.

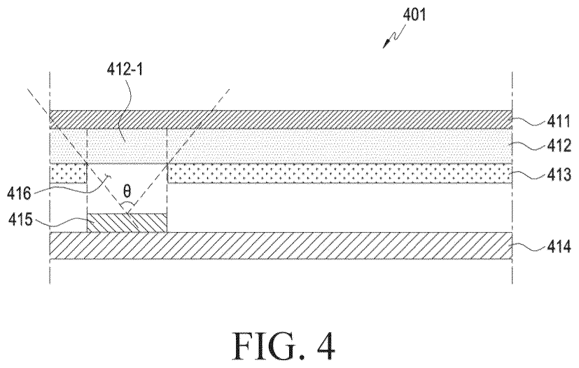

FIG. 4 is a cross-sectional view illustrating an electronic device 401 according to an embodiment.

Referring to FIG. 4, in an embodiment, the electronic device 401 may include a glass 411, a display panel 412, a cover panel 413, a printed circuit board (PCB) 414, and/or an illuminance sensor 415.

In an embodiment, the glass 411 is attached to the front surface of the display panel 412 and may be implemented as a flexible and transparent material (e.g., colorless polyimide (CPI)).

In an embodiment, the display panel 412 may be disposed in at least a partial area of the lower portion of the glass 411. The display panel 412 may display a screen through the glass 411 formed of a transparent material.

In an embodiment, the display panel 412 may include a light-transmitting area 412-1 (hereinafter referred to as a “first area of the display” or a “first area of the display panel 412”) so that the illuminance sensor 415 measures the intensity of light. In an embodiment, an illuminance sensor 415 may be disposed under the first area 412-1 of the display panel 412. The position and/or size of the first area 412-1 of the display panel 412 may be determined based on the position and/or size of the illuminance sensor 415. For example, the position and/or size of the first area 412-1 of the display panel 412 may be determined based on the field of view (FOV) of the illuminance sensor 415.

In an embodiment, the first area 412-1 of the display panel 412 may be implemented to have a lower pixel density (e.g., pixels per inch (PPI)) and/or a lower line density than other areas of the display panel 412 to enhance light transmittance.

In an embodiment, the cover panel 413 may be a layer protecting one surface of the display panel 412. The cover panel 413 may include a metal layer (e.g., a copper sheet) and/or a light blocking layer (e.g., a black embossed layer). In an embodiment, the cover panel 413 may be disposed on a lower end of the display panel 412.

In an embodiment, the illuminance sensor 415 may be mounted on the PCB 414. In an embodiment, the illuminance sensor 415 may measure external illuminance by detecting external light that has passed through the glass 411 and the display panel 412. In an embodiment, since the cover panel 413 includes a light blocking layer, the cover panel 413 may not transmit external light. In order for the illuminance sensor 415 to detect external light, an opening 416 may be formed in at least a portion of the cover panel 413. The opening 416 of the cover panel 413 may be formed at a position and/or a size corresponding to the field of view θ of the illuminance sensor 415.

In an embodiment, the illuminance sensor 415 may be implemented in the form of a package further including a light emitting unit. For example, when the illuminance sensor 415 further includes a light emitting unit, the illuminance sensor 415 may operate as a proximity sensor.

In an embodiment, the illuminance sensor 415 may be included in the display panel 412. For example, at least a portion of the pixels included in the display panel 412 may include a light receiving unit to measure illuminance. In this case, the opening 416 may not be formed.

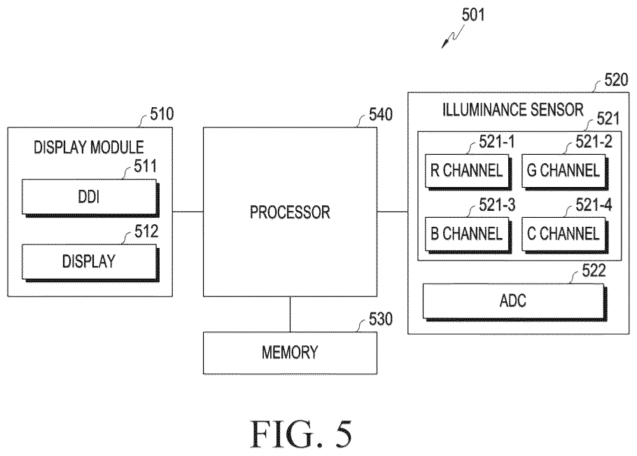

FIG. 5 is a block diagram illustrating an electronic device 501 according to an embodiment.

Referring to FIG. 5, in an embodiment, the electronic device 501 may be the electronic device 101 of FIG. 1, the electronic device 310, 320 of FIG. 3, or the electronic device 401 of FIG. 4.

In an embodiment, the electronic device 501 may include a display module 510, an illuminance sensor 520, memory 530, and/or a processor 540.

In an embodiment, the display module 510 may be the display module 160 of FIGS. 1 and 2 or the display 311, 321 of FIG. 3.

In an embodiment, the display module 510 may include a DDI 511 (e.g., the DDI 230 of FIG. 2) and a display 512 (e.g., the display 210 of FIG. 2 and the display panel 412 of FIG. 4).

In an embodiment, the DDI 511 is identical or similar to the DDI 230 of FIG. 2, and a repeated description thereof is omitted.

In an embodiment, the DDI 511 may transfer color information about an image displayed through the display module 510 to the processor 540. In an embodiment, the color information about the image may include color on pixel ratio (COPR) information about the image. In an embodiment, the color information about the image displayed through the display module 510 may be color information about an image portion displayed through the first area of the display 512 (e.g., the first area 412-1 of the display panel 412 of FIG. 4) in the image displayed through the display 512. However, the disclosure is not limited thereto, and the color information about the image displayed through the display module 510 may be color information about the entire image displayed through the entire area of the display 512.

In an embodiment, the COPR information about the image portion displayed through the first area of the display 512 may include red, green, and blue (RGB) values of the image portion to be displayed through the first area of the display 512. For example, the COPR information about the image portion displayed through the first area of display 512 may include an average of R values, an average of G values, and an average of B values displayed by the pixels included in the first area of display 512. For example, when a white image portion is displayed through the first area of the display 512, the COPR information about the image portion displayed through the first area of the display 512 may have RGB values (255, 255, 255).

In an embodiment, the DDI 511 controls the display 512 to display an image in units of frames (e.g., image frames), and may transfer color information about the image (e.g., the COPR information about the image) to the processor 540 in each frame.

In an embodiment, the display 512 may be the display 210 of FIG. 2 and/or the display panel 412 of FIG. 4. In an embodiment, the display 512 may be driven in a pulse width modulation (PWM) scheme. For example, while displaying the screen, the display 512 may be periodically turned on/off based on a set duty cycle and screen refresh rate.

In an embodiment, the illuminance sensor 520 may be the illuminance sensor 520 included in the sensor module 176 of FIGS. 1 and 2, the illuminance sensor 313, 323 of FIG. 3, and/or the illuminance sensor 415 of FIG. 4.

In an embodiment, the illuminance sensor 520 (also referred to as an “ambient light sensor” or a “light sensor”) may include a light receiving unit 521 for reading the RGB values of visible light and an analog-to-digital converter (ADC) 522 for digitizing RGB values.

In an embodiment, the light receiving unit 521 may include a photodiode that reacts to visible light (e.g., light having a wavelength of about 400 nm to 750 nm). The light receiving unit 521 may further include a photodiode that receives infrared rays.

In an embodiment, the light receiving unit 521 may include a plurality of channels capable of measuring light. For example, the light receiving unit 521 may include a red (R) channel 521-1 that receives light in a red spectrum (e.g., light with a wavelength of about 550 nm to 700 nm), a green (G) channel 521-2 that receives light in a green spectrum (e.g., light with a wavelength of about 450 nm to 650 nm), a blue (B) channel 521-3 that receives light in a blue spectrum (e.g., light with a wavelength of about 400 nm to 550 nm), and/or a clear (C) channel 521-4 that receives white light (e.g., all of R, G, and B). At least one of the plurality of channels may include a photodiode. Each of the R channel 521-1, G channel 521-2, and B channel 521-3 may include a filter that transmits light of the corresponding spectrum.

In an embodiment, the ADC 522 may convert the analog data transferred from the light receiving unit 521 into digital data (e.g., an ADC value). In an embodiment, the ADC 522 may include one or more ADCs. For example, the ADC 522 may include a first ADC that samples the data transferred from the light receiving unit 521 in a first cycle and a second ADC that samples the data transferred from the light receiving unit 521 in a second cycle different from the first cycle.

In an embodiment, the memory 530 may be the memory 130 of FIG. 1.

In an embodiment, the memory 530 may store information for performing an operation of calibrating the illuminance sensor 520.

In an embodiment, the processor 540 may be the processor 120 of FIG. 1.

In an embodiment, the processor 540 may control an overall operation of calibrating the illuminance sensor 520. In an embodiment, the processor 540 may include one or more processors for performing an operation of calibrating the illuminance sensor 520. For example, the processor 540 may include an application processor (e.g., the main processor 121 of FIG. 1) and a sensor hub processor (e.g., the auxiliary processor 123 of FIG. 1). When the processor 540 includes an application processor and a sensor hub processor, the sensor hub processor may perform an overall operation of calibrating the illuminance sensor 520 based on the information transferred from the display module 510, the illuminance sensor 520, the memory 530, and the application processor. An operation of calibrating the illuminance sensor 520 by the processor 540 is described in detail with reference to the drawings.

In FIG. 5, the electronic device 501 is illustrated as including the display module 510, the illuminance sensor 520, memory 530, and/or the processor 540, but the disclosure is not limited thereto. For example, the electronic device 501 may further include one or more components included in the electronic device 501 of FIG. 1.

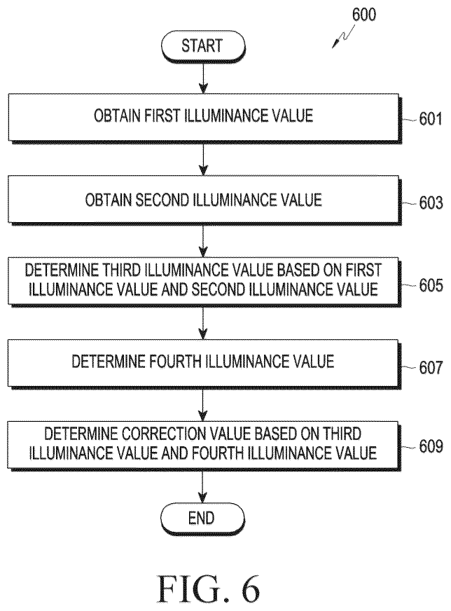

FIG. 6 is a flowchart 600 illustrating a method for calibrating an illuminance sensor 520 according to an embodiment.

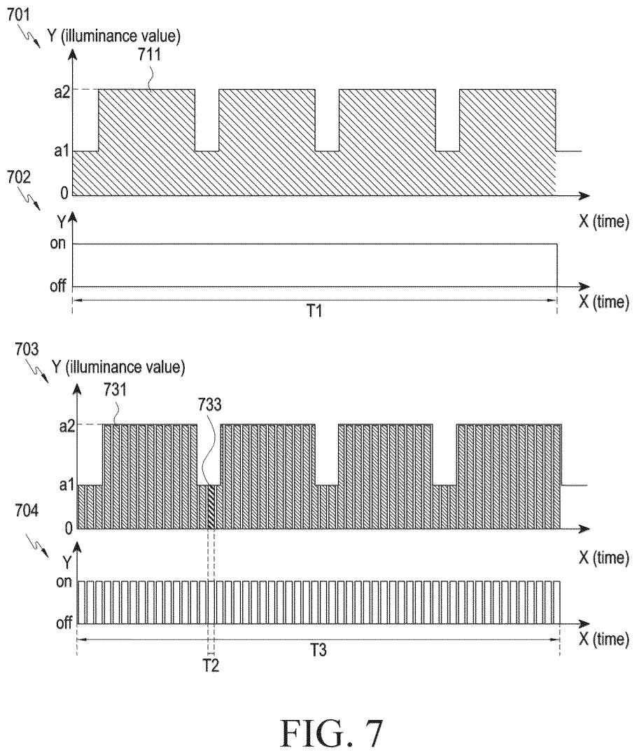

FIG. 7 is a view illustrating a method for calibrating an illuminance sensor 520 according to an embodiment.

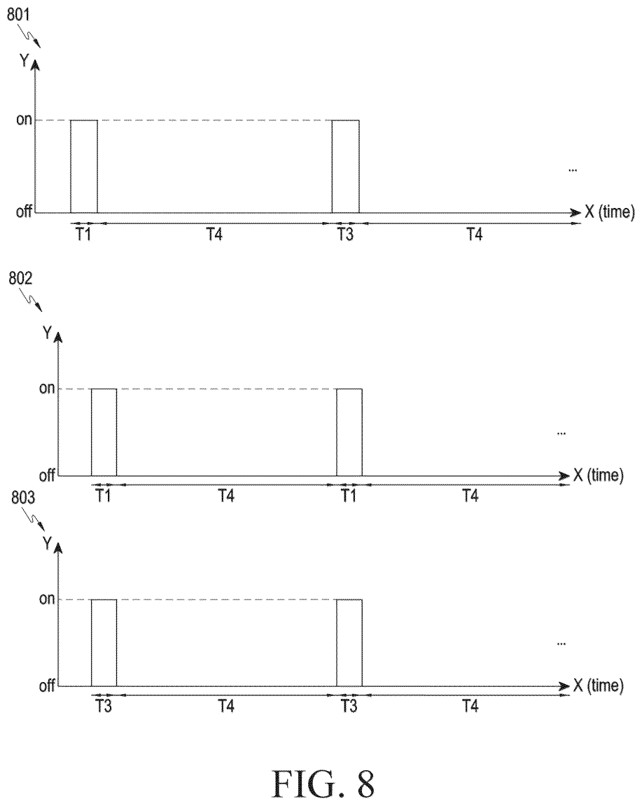

FIG. 8 is a view illustrating a method for calibrating an illuminance sensor 520 according to an embodiment.

Before describing FIGS. 6 to 8, the principle used to determine a correction value (hereinafter referred to as a “correction value,” a “correction coefficient,” or “correction information”) for determining a final illuminance value from the illuminance value measured through the illuminance sensor 520, to be described through FIGS. 6 to 8 (e.g., an illuminance value determined to be measured solely under the influence of external light without the influence of the display light, which is calculated by correcting the illuminance value measured through the illuminance sensor 520) (hereinafter, referred to as a “corrected illuminance value”) is described.

In an embodiment, the corrected illuminance value may be calculated by the following Equation 1.

$$corrected illuminance value = illuminance value measured by illuminance {sensor}^{*} correction value - COPR illuminance value \qquad [ Equation 1 ]$$

Equation 1 above is merely an example for helping understanding and, without limitations thereto, may be modified, applied, or expanded in various ways.

In an embodiment, in Equation 1, the “illuminance value measured by the illuminance sensor” may be an illuminance value obtained based on the illuminance data output by the ADC of the illuminance sensor. In Equation 1, the “COPR illuminance value” may be a value determined based on color information about an image (e.g., the COPR information) and information related to the luminance of the display (e.g., luminance code corresponding to the luminance currently set on the display). In an embodiment, the COPR illuminance value may be an illuminance value estimated to be an illuminance value measured by the illuminance sensor that is affected by display light (e.g., the brightness of the image displayed through the display and brightness of the display). Hereinafter, the COPR illuminance value is also referred to as a “display light estimation value”.

In an embodiment, in Equation 1, the “illuminance value measured by the illuminance sensor” may include an illuminance value measured through the illuminance sensor by the external light and an illuminance value measured through the illuminance sensor by the display light. For example, the illuminance value measured by the illuminance sensor may be represented as the sum of the illuminance value measured through the illuminance sensor 520 by the external light and the illuminance value measured through the illuminance sensor 520 by the display light. Accordingly, Equation 1 may be represented as Equation 2 below.

$$corrected illuminance value = {( illuminance value measured through illuminance sensor by external light + illuminance value measured through illuminance sensor by display light )}^{*} correction value - COPR illuminance value \qquad [ Equation 2 ]$$

Equation 2 above is merely an example for helping understanding, but is not limited thereto, and may be modified, applied, or extended in various ways.

In an embodiment, using Equation 2, the correction value may be represented as the following Equation 3.

$$correction value = ( corrected illuminance value + COPR illuminance value ) / ( illuminance value measured through illuminance sensor by external light + illuminance value measured through illuminance sensor by display light ) \qquad [ Equation 3 ]$$

Equation 3 above is merely an example for helping understanding and, without limitations thereto, may be modified, applied, or expanded in various ways.

In an embodiment, as described above, calibration for the illuminance sensor may be performed in the darkroom condition (darkroom environment) in which external light is blocked in the process step. Similar to the darkroom condition of the process step, the correction value may be determined by excluding the illuminance values affected by the external light while the user is using the electronic device (e.g., while the electronic device displays the screen). For example, assuming that the electronic device performs the operation of calibrating the illuminance sensor in the darkroom condition, in Equation 3, the “corrected illuminance value” affected by the external light and the “illuminance value measured through the illuminance sensor by the external light” may be replaced by zero. In this case, Equation 3 may be represented as Equation 4 below.

$$correction value = ( COPR illuminance value ) / ( illuminance value measured through illuminance sensor by display light ) \qquad [ Equation 4 ]$$

Equation 4 above is merely an example for helping understanding, but is not limited thereto, and may be modified, applied, or extended in various ways.

In an embodiment, the correction value may be determined by calculating the COPR illuminance value and the illuminance value measured through the illuminance sensor by the display light (e.g., the illuminance value measured through the illuminance sensor only by the influence of the display light without the influence of external light), as illustrated in Equation 4.

In the following embodiment, each operation may be sequentially performed, but is not necessarily performed sequentially. For example, the order of the operations may be changed, and at least two operations may be performed in parallel.

According to an embodiment, operations 601 to 609 may be understood to be performed by the processor (e.g., the processor 540 of FIG. 5) of the electronic device (e.g., the electronic device 501 of FIG. 5).

Referring to FIG. 6, in operation 601, in an embodiment, the processor (e.g., the processor 540 of FIG. 5) may obtain a first illuminance value (hereinafter referred to as “first illuminance value”) based on the illuminance data obtained through the illuminance sensor (e.g., the illuminance sensor 520 of FIG. 5) during a first time (hereinafter referred to as a “first time” or “long itime”) while the display (e.g., the display 512 of FIG. 5) is turned on/off.

In an embodiment, reference numeral 701 of FIG. 7 may indicate the illuminance value calculated based on illuminance data obtained through illuminance sensor 520 while the display 512 is turned on/off (e.g., while the display 512 is driven in a PWM manner to display an image) over time. Reference numeral 702 in FIG. 7 may indicate the first time T1 when the illuminance sensor 520 measures light (e.g., when the light receiving unit 521 of the illuminance sensor 520 of FIG. 5 is on) over time. In the present application, the expression that “a display is (repeatedly) turned on and off” may refer to a case where the display is being driven in a PWM manner, for example, through rapid on/off switching of the display's backlight or drive signals to control brightness over time. It should be noted that the phrase “turned on/off” or “turned on and off” in the present disclosure refer to the periodic or non-periodic switching inherent to PWM control, and does not necessarily imply that the display's power is being fully turned on and off, although such full power cycling may also be encompassed in some embodiments.

In an embodiment, the light received by the illuminance sensor 520 during the first time T1 may include display light and external light. In reference numeral 701, the illuminance value a2 may be the illuminance value measured through the illuminance sensor 520 by the display light and external light while the display 512 is turned on, and the illuminance value a1 smaller than the illuminance value a2 may be the illuminance value measured through the illuminance sensor 520 by only the external light while the display 512 is turned off.

In an embodiment, the processor 540 may obtain the first illuminance value based on the illuminance data obtained through the illuminance sensor 520 during the first time T1 when the display 512 is turned on/off. For example, the processor 540 may obtain the first illuminance value (also referred to as “long itime lux”) (e.g., average illuminance value obtained during the first time T1) by dividing the illuminance values (e.g., the area 711 in reference numeral 701) obtained based on the illuminance data obtained during the first time T1) by the first time T1.

In an embodiment, the first illuminance value may be the illuminance value obtained by the display light and external light received by the illuminance sensor 520 during the first time T1 when the display 512 is turned on/off.

In operation 603, in an embodiment, the processor 540 may obtain the second illuminance value based on the illuminance data obtained through the illuminance sensor 520 at a second time (hereinafter referred to as a “second time” or “short itime”) shorter than the first time while the display 512 is turned on/off.

In an embodiment, reference numeral 703 of FIG. 7 may indicate the illuminance value calculated based on illuminance data obtained through illuminance sensor 520 while the display 512 is turned on/off (e.g., while the display 512 is driven in a PWM manner to display an image) over time. Reference numeral 704 in FIG. 7 may indicate the second time T2 when the illuminance sensor 520 periodically measures light during the third time T3 (hereinafter referred to as a “third time”) (e.g., when the light receiving unit 521 of the illuminance sensor 520 of FIG. 5 is turned on or the ADC 522 samples the data transferred from the light receiving unit 521. In an embodiment, the third time T3 may be set to be equal to the first time T1. For example, the third time T3 and the first time T1 may be set to a time in a range of about 16 ms to about 20 ms. However, the disclosure is not limited thereto, and the third time T3 may be set to be different from the first time T1. In an embodiment, the second time T2 may be set to a time (e.g., about 0.4 ms) shorter than the third time T3 and the first time T1. In an embodiment, the second time T2 may be a time (e.g., a time interval) obtained by evenly dividing the third time T3 by a designated number. In an embodiment, the third time T3 may include a designated number of second times T2.

In an embodiment, the processor 540 may obtain a plurality of illuminance values based on the illuminance data obtained through the illuminance sensor 520 at each of the plurality of second times T2 during the third time T3. The processor 540 may determine the minimum value among the plurality of obtained illuminance values as the second illuminance value. For example, the plurality of obtained illuminance values may include the illuminance value measured through the illuminance sensor 520 by the display light and external light while the display 512 is turned on (e.g., the value obtained by dividing the area 731 by the second time T2 or a2) and the illuminance value measured through the illuminance sensor 520 by the external light while the display 512 is turned off (e.g., the value obtained by dividing the area 733 by the second time T2 or a1). The second illuminance value as the minimum value among the plurality of obtained illuminance values may be the illuminance value (also referred to as “short itime min lux”) measured through the illuminance sensor 520 by the external light while the display 512 is turned off (e.g., in the time interval when the display 512 is turned off).

In an embodiment, in FIG. 6, operation 601 is illustrated as being performed prior to operation 603, but the disclosure is not limited thereto. For example, operation 603 may be performed before operation 601. For example, operations 601 and 603 may be performed in parallel (e.g., simultaneously).

In an embodiment, the illuminance sensor 520 may repeatedly and alternately perform the operation of obtaining illuminance data for the first time T1 and the operation of obtaining illuminance data for the third time T3. For example, as illustrated in reference numeral 801 of FIG. 8, the illuminance sensor 520 may be turned on for the first time T1 (e.g., performing a light receiving operation to obtain a first illuminance value), and after a waiting time (e.g., a time when the illuminance sensor 520 is in a standby or sleep state), may be turned on for the third time (e.g., a light receiving operation to obtain a second illuminance value and a sampling operation performed by the ADC 522 may be performed).

In an embodiment, the illuminance sensor 520 may simultaneously perform the operation of obtaining illuminance data during the first time T1 and an operation of obtaining illuminance data during the third time T3. For example, as shown by reference numeral 802 and reference numeral 803 in FIG. 8, when the first time T1 and the third time T3 are set to the same time, the illuminance sensor 520 may obtain illuminance data to obtain the first illuminance value through the first ADC, which performs the sampling operation with a first time T1 period during the first time T1 (and third time T3), and obtain illuminance data to obtain the second illuminance value through the second ADC, which performs the sampling operation with a second time T2 period. The illuminance sensor 520 may perform the operation of obtaining illuminance data through the first ADC and the second ADC for the first time T1 and, after the waiting time T4, may perform the operation of obtaining illuminance data through the first ADC and the second ADC again.

In operations 605, in an embodiment, the processor 540 may determine a third illuminance value (hereinafter referred to as a “third illuminance value”) related to light emitted from the display 512 based on the first illuminance value and the second illuminance value. For example, based on the first illuminance value obtained through operation 601 and the second illuminance value obtained through operation 603, the processor 540 may calculate the third illuminance value as an illuminance value determined to be measured by the display sensor 520 only with the influence of light without the influence of external light. For example, the processor 540 may calculate the third illuminance value by subtracting the second illuminance value from the first illuminance value.

In an embodiment, the third illuminance value may be substantially the same as the “illuminance value measured through the illuminance sensor by display light” in Equation 4 described above.

In operations 607, in an embodiment, the processor 540 may determine a fourth illuminance value (e.g., a display light estimation value) based on color information about the image displayed through the display 512 and information related to the luminance of the display 512.

In an embodiment, the color information about the image displayed through the display 512 may include COPR information about the image displayed through the display 512 (e.g., being displayed through the display 512). For example, the color information about the image displayed through the display 512 may include red, green, and blue (RGB) values of the image portion displayed through the first area of the display 512 (e.g., the first area 412-1 of the display panel 412 of FIG. 4).

In an embodiment, the information related to the luminance of the display 512 may include the currently set luminance level of the display 512 (or also referred to as a “luminance code”) (or a luminance value).

In an embodiment, the processor 540 may determine (e.g., calculate) the fourth illuminance value using the following Equation 5 to Equation 7.

$$COPR W = a * {( COPR R )}^{2.2} + b * {( COPR G )}^{2.2} + c * {( COPR B )}^{2.2} \qquad [ Equation 5 ]$$

Equation 5 above is merely an example for helping understanding, but is not limited thereto, and may be modified, applied, or extended in various ways.

In an embodiment, in Equation 5, COPR R, COPR G, and COPR B may represent an R value, a G value, and a B value, respectively, of the image displayed through the display 512. For example, in Equation 5, COPR R, COPR G, and COPR B may represent the average R value, the average G value, and the average B value, respectively, of the image portion displayed through the first area of the display 512. In Equation 5, “2.2” may indicate the gamma value of the display 512, and a value different from 2.2 may be used in Equation 5 according to the setting of the gamma value of the display 512. In Equation 5, a, b, and c may be coefficients for calculating COPR W.

$$brightness coefficient = {{d}^{*} ( luminance code )}^{2} + {e}^{*} ( luminance code ) + f \qquad [ Equation 6 ]$$

Equation 6 above is merely an example for helping understanding and, without limitations thereto, may be modified, applied, or expanded in various ways.

In an embodiment, in Equation 6, the luminance code may be a value corresponding to the current luminance value of the display 512 (e.g., a luminance value currently set in the display 512). For example, the luminance from the minimum to the maximum luminance of the display 512 (e.g., the overall luminance range of the display 512) may be classified into a designated number (e.g., 256) of luminance ranges according to the luminance size. The luminance codes may be set to correspond to the classified luminance ranges, respectively. For example, when the overall luminance range of the display 512 is classified into 256 luminance codes, the luminance codes may be set so that the minimum luminance of the display 512 belongs to the luminance code “0” and the maximum luminance of the display 512 belongs to the luminance code “255”. In Equation 6, d, e, and f may be coefficients for calculating the brightness coefficient. In Equation 6, the brightness coefficient is represented as a quadratic equation for the luminance code, but the disclosure is not limited thereto.

$$COPR illuminance value = COPR {W}^{*} brightness coefficient \qquad [ Equation 7 ]$$

Equation 7 above is merely an example for helping understanding and, without limitations thereto, may be modified, applied, or expanded in various ways.

In an embodiment, as shown in Equation 7, the COPR illuminance value may be calculated by multiplying the COPR W calculated using Equation 5 and the brightness coefficient calculated using Equation 6. For example, the processor 540 may calculate COPR W by obtaining the color information about the image displayed through the display 512 from the DDI (e.g., the DDI 511 of FIG. 5) and using Equation 5 based on the obtained color information about the image. The processor 540 may calculate the brightness coefficient of Equation 6 by identifying the luminance code of the display 512 stored in the memory (e.g., the memory 530 of FIG. 5) and currently set. The processor 540 may calculate the COPR illuminance value as a fourth illuminance value based on the obtained color information about the image and the brightness coefficient.

In an embodiment, the fourth illuminance value (e.g., the COPR illuminance value) determined through Equation 5 to Equation 7 may correspond to the COPR illuminance value of Equation 4.

In operations 609, in an embodiment, the processor 540 may determine a correction value for correcting the illuminance value obtained through the illuminance sensor 520 based on the third illuminance value and the fourth illuminance value. For example, the processor 540 may calculate a correction value (correction coefficient) for correcting the illuminance value to be obtained through the illuminance sensor 520 based on the third illuminance value obtained through operation 605 and the fourth illuminance value obtained through operation 607. For example, the processor 540 may determine a correction value for correcting the illuminance value obtained through the illuminance sensor 520 by dividing the fourth illuminance value by the third illuminance value using Equation 4.

In an embodiment, although not illustrated in FIG. 6, the processor 540 may obtain the illuminance value through the illuminance sensor 520 after the correction value is determined. The processor 540 may obtain a final illuminance value (e.g., a corrected illuminance value) based on the illuminance value obtained through the illuminance sensor 520 and the correction value using Equation 1. For example, the processor 540 may obtain the illuminance value (e.g., the illuminance value measured through the illuminance sensor 520) through the illuminance sensor 520 after the correction value is determined. The processor 540 may calculate the COPR illuminance value using Equation 5, Equation 6, and Equation 7 based on the color information about the image displayed through the display 512 and the luminance code currently set in the display 512. Using Equation 1, the processor 540 may calculate the corrected illuminance value by subtracting the calculated COPR illuminance value from the product of the illuminance value obtained through the illuminance sensor 520 and the correction value.

Although not illustrated in FIG. 6, in an embodiment, the processor 540 may detect that the display module 510 and/or the illuminance sensor 520 are replaced. For example, the processor 540 may compare the identification (ID) of the display module and/or illuminance sensor stored in the memory 530 before the replacement of the display module 510 and/or illuminance sensor 520 and the identification of the display module 510 and/or the illuminance sensor 520 currently mounted in the electronic device 501 while the electronic device 501 performs a booting operation. When the identification of the display module stored in the memory 530 and the identification of the display module 510 currently mounted in the electronic device 501 are different, or the identification of the illuminance sensor stored in the memory 530 and the identification of the illuminance sensor 520 currently mounted in the electronic device 501 are different, the processor 540 may determine that the display module 510 and/or the illuminance sensor 520 has been replaced. When it is determined that the display module 510 and/or the illuminance sensor 520 has been replaced, the processor 540 may perform a calibration operation (e.g., operations 601 to 609) on the illuminance sensor 520.

In FIG. 6, a method for calculating the correction value using the first illuminance value obtained based on the illuminance data obtained through the illuminance sensor 520 for the first time while the display 512 is on/off and the second illuminance value obtained through the illuminance sensor 520 for the second time while the display 512 is on/off has been described, but the disclosure is not limited thereto. Hereinafter, a method for calculating the correction value using the operations of FIG. 6 is referred to as a “first method”.

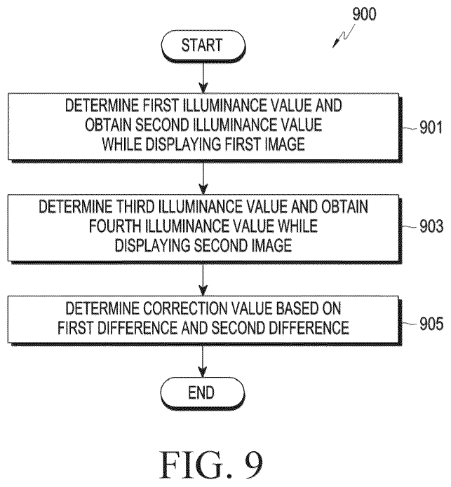

FIG. 9 is a flowchart 900 illustrating a method for calibrating an illuminance sensor 520 according to an embodiment.

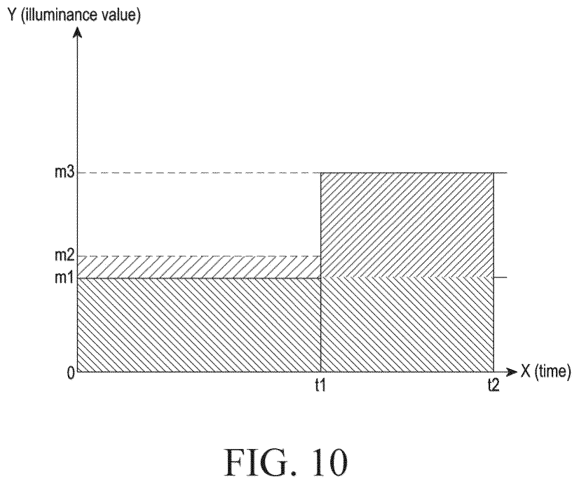

FIG. 10 is a view illustrating a method for calibrating an illuminance sensor 520 according to an embodiment.

Before describing FIGS. 9 and 10, a principle used to determine a correction value (correction coefficient), which is described with reference to FIGS. 9 and 10, is described.

In an embodiment, the difference between the final illuminance value calculated while the first image is displayed through the display (e.g., the display 512 of FIG. 5) and the final illuminance value calculated while the second image (e.g., the image displayed after the first image) is displayed through the display 512 may be calculated as shown in Equation 8 below using the above-described Equation 1.

$$( corrected second illuminance value ) - ( corrected first illuminance value ) = ( second illuminance value measured by the illuminance {sensor}^{*} correction value - second COPR illuminance value ) - ( first illuminance value measured by the illuminance {sensor}^{*} correction value - first COPR illuminance value ) \qquad [ Equation 8 ]$$

Equation 8 above is merely an example for helping understanding and, without limitations thereto, may be modified, applied, or expanded in various ways.

In an embodiment, in Equation 8, the “corrected first illuminance value” and the “corrected second illuminance value” may indicate the final illuminance value calculated during the display of the first image and the final illuminance value calculated during the display of the second image, respectively. In Equation 8, the “first illuminance value measured by the illuminance sensor” and the “second illuminance value measured by the illuminance sensor” may indicate the illuminance value measured through the illuminance sensor while the first image is displayed, and the illuminance value measured through the illuminance sensor while the second image is displayed, respectively. In Equation 8, the “first COPR illuminance value” and the “second illuminance value” may indicate the COPR illuminance value calculated during the display of the first image and the COPR illuminance value calculated during the display of the second image, respectively.

In an embodiment, in Equation 8, the “second illuminance value measured by the illuminance sensor” may be represented as the sum of the illuminance value measured by the external light through the illuminance sensor while the second image is displayed, and the illuminance value measured by the display light through the illuminance sensor while the second image is displayed. In Equation 8, the “first illuminance value measured by the illuminance sensor” can be expressed as the sum of the illuminance value measured through the illuminance sensor by the external light while the first image is displayed, and the illuminance value measured through the illuminance sensor by the display light while the first image is displayed.

In an embodiment, as described above, calibration for the illuminance sensor may be performed in the darkroom condition (darkroom environment) in which external light is blocked in the process step. Similar to the darkroom condition of the process step, the correction value may be determined by excluding the illuminance values affected by the external light while the user is using the electronic device (e.g., while the electronic device displays the screen). For example, assuming that the electronic device performs the operation of calibrating the illuminance sensor in the darkroom condition, in Equation 8, the “corrected first illuminance value” and the “corrected second illuminance value” may be replaced by zero. In this case, Equation 8 may be represented as Equation 9 below.

$$correction value = ( second COPR illuminance value - first COPR illuminance value ) / ( second illuminance value measured by the illuminance sensor - first illuminance value measured by the illuminance sensor ) \qquad [ Equation 9 ]$$

Equation 9 above is merely an example for helping understanding, but is not limited thereto, and may be modified, applied, or extended in various ways.

In an embodiment, the second illuminance value measured by the illuminance sensor and the first illuminance value measured by the illuminance sensor may include the illuminance value measured through the illuminance sensor by the external light and display light while the second image is displayed, and the illuminance value measured through the illuminance sensor by the external light and display light while the first image is displayed. In Equation 9, by subtracting the first illuminance value measured by the illuminance sensor from the second illuminance value measured by the illuminance sensor, it is possible to exclude the illuminance value measured through the illuminance sensor by the external light while the first image is displayed, and the illuminance value measured through the illuminance sensor by the external light while the second image is displayed. For example, in FIG. 10, the first image may be displayed through the display in a first time interval (0 to t1), and the second image may be displayed through the display in a second time interval (t1 to t2). In the first time interval, the first illuminance value m2 measured through the illuminance sensor may include an illuminance value m1 measured through the illuminance sensor by the external light and an illuminance value m2-m1 measured by the display light displaying the first image. In the second time interval, the second illuminance value m3 measured through the illuminance sensor may include an illuminance value m1 measured through the illuminance sensor by the external light and an illuminance value m3-m1 measured by light of the display 512 displaying the second image. In Equation 9, by subtracting the first illuminance value m2 measured by the illuminance sensor from the second illuminance value m3 measured by the illuminance sensor, it is possible to exclude the illuminance value m1 measured by the illuminance sensor by the external light while the first image and the second image are displayed. Accordingly, the correction value may be determined under the condition that excludes the illuminance value affected by the external light while the user uses the electronic device (e.g., while the electronic device sequentially displays the first and second images as different images).

In the following embodiment, each operation may be sequentially performed, but is not necessarily performed sequentially. For example, the order of the operations may be changed, and at least two operations may be performed in parallel.

According to an embodiment, operations 901 to 905 may be understood to be performed by the processor (e.g., the processor 540 of FIG. 5) of the electronic device (e.g., the electronic device 501 of FIG. 5).

Referring to FIGS. 9 and 10, in operation 901, in an embodiment, the processor 540 may determine a first illuminance value (hereinafter referred to as a “first illuminance value”) (e.g., a display light estimation value) based on color information about a first image and information related to the luminance of the display 512 while the first image is displayed through the display 512, and may obtain a second illuminance value (hereinafter referred to as a “second illuminance value”) through the illuminance sensor (e.g., the illuminance sensor 520 of FIG. 5).

In an embodiment, the processor 540 may determine the first illuminance value (e.g., the display light estimation value) based on the color information about the first image and information related to the luminance of the display 512 while the first image is displayed through the display 512. For example, the processor 540 may calculate the COPR illuminance value as the first illuminance value (e.g., the display light estimation value) using the above-described Equation 5 to Equation 7 while the first image is displayed. The operation of determining the first illuminance value is at least partially identical or similar to operation 607 of FIG. 6, and thus a detailed description thereof is omitted.

In an embodiment, the second illuminance value may be obtained based on the illuminance data obtained through the illuminance sensor 520 for a first time (e.g., long itime) while the first image is displayed through the display 512, while the display 512 is turned on/off. The second illuminance value may be the illuminance value obtained by the display light and external light received by the illuminance sensor 520 during the first time when the display 512 is turned on/off to display the first image. The operation of obtaining the second illuminance value through the illuminance sensor 520 is at least partially the same or similar to the operation of obtaining a long itime lux based on the illuminance data obtained during the long itime, described with reference to operations 601 and reference numeral 701 of FIG. 7, and reference numeral 702 of FIG. 7, so a detailed description is omitted.

In operations 903, in an embodiment, the processor 540 may determine a third illuminance value (hereinafter referred to as a “third illuminance value”) (e.g., the display light estimation value) based on the color information about the second image and information related to the luminance of the display 512 while the second image is displayed through the display 512, and obtain a fourth illuminance value (hereinafter referred to as a “fourth illuminance value”) through the illuminance sensor 520.

In an embodiment, the second image may be an image displayed through the display 512 after displaying the first image. In an embodiment, the processor 540 may detect that the image displayed through the display 512 is changed from the first image to the second image after performing operation 901 while the first image is displayed. The processor 540 may perform operation 903 based on detecting that the image displayed through the display 512 is changed from the first image to the second image.

In an embodiment, the processor 540 may determine a third illuminance value (e.g., the display light estimation value) based on the color information about the second image and information related to the luminance of the display 512 while the second image is displayed through the display 512. For example, while the second image is displayed, the processor 540 may calculate the COPR illuminance value as the third illuminance value (e.g., the display light estimation value) using the above-described Equation 5 to Equation 7. The operation of determining the third illuminance value is at least partially identical or similar to operation 607 of FIG. 6, and thus a detailed description thereof is omitted.

In an embodiment, while the second image is displayed through the display 512 and while the display 512 is turned on/off, the fourth illuminance value may be obtained based on the illuminance data obtained through the illuminance sensor 520 for a first time (e.g., the long itime). The fourth illuminance value may be the illuminance value obtained by the display light and external light received by the illuminance sensor 520 during the first time when the display 512 is turned on/off to display the second image. The operation of obtaining the fourth illuminance value through the illuminance sensor 520 is at least partially the same or similar to the operation of obtaining the long itime lux based on the illuminance data obtained during the long itime described through operations 601 and reference numeral 701 of FIG. 7, and reference numeral 702 of FIG. 7, so a detailed description is omitted.

In operations 905, the processor 540 may determine a correction value for correcting the illuminance value obtained through the illuminance sensor 520 based on the first difference between the third illuminance value and the first illuminance value and the second difference between the fourth illuminance value and the second illuminance value. For example, the third illuminance value, the first illuminance value, the fourth illuminance value, and the second illuminance value may be the second COPR illuminance value, the first COPR illuminance value, the second illuminance value measured by the illuminance sensor 520, and the first illuminance value measured by the illuminance sensor 520 in Equation 9. The processor 540 may calculate the correction value (correction coefficient) using Equation 9 based on the third illuminance value, the first illuminance value, the fourth illuminance value, and the second illuminance value.

Hereinafter, a method for calculating the correction value using the operations of FIG. 9 is referred to as a “second method”.

In an embodiment, the processor 540 may further perform the operation of adjusting the determined correction value after the correction value is determined using the first method or the second method. For example, because the environment in which the user uses the electronic device 501 and the darkroom environment are different, there may be a difference between the correction value calculated by performing calibration on the illuminance sensor while the user uses the electronic device 501 (e.g., the correction value determined by performing the operations of FIG. 6 or FIG. 9) and the correction value calculated by performing calibration on the illuminance sensor in the darkroom environment. Accordingly, after the correction value is determined, the processor 540 may perform the operation of adjusting the determined correction value to compensate for the difference. In an embodiment, the processor 540 may determine the final correction value by calculating (e.g., multiplying) the determined correction value with a designated ratio to compensate for the difference. The designated ratio (e.g., about 0.9) calculated (e.g., multiplied) with the determined correction value may be a value determined by an experiment (or test).

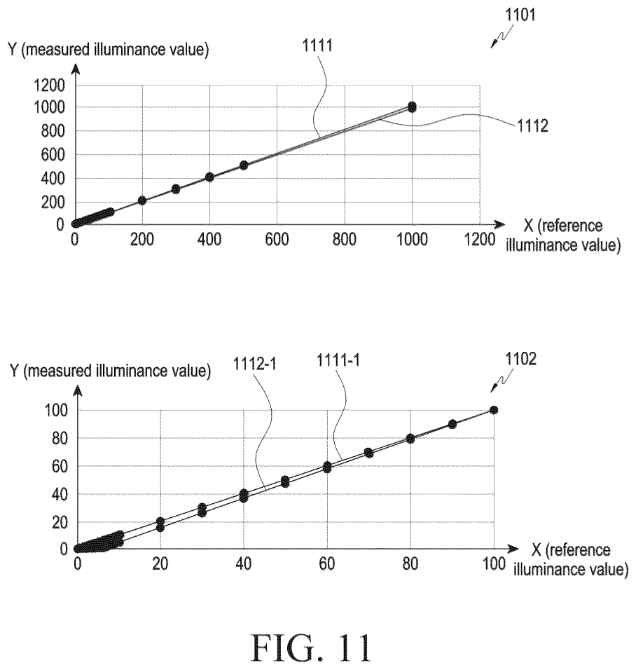

FIG. 11 is a view illustrating a method for calibrating an illuminance sensor 520 according to an embodiment.

Referring to FIG. 11, as described through operation 603 of FIG. 6, in an embodiment, to determine the correction value using the first method, the processor (e.g., the processor 540 of FIG. 5) may obtain a long itime lux based on the illuminance data obtained through the illuminance sensor (e.g., the illuminance sensor 520 of FIG. 5) during the first time (e.g., the long itime) when the display (e.g., the display 512 of FIG. 5) is turned on/off and may obtain a short itime min lux based on the illuminance data obtained through the illuminance sensor (520) at each second time period (e.g., the short itime) shorter than the first time while the display 512 is turned on/off.

In an embodiment, when the illuminance value by the external light measured through the illuminance sensor 520 is less than or equal to the threshold illuminance value, the accuracy of the correction value determined using the first method may be lowered.

In an embodiment, the second time used to calculate the short itime min lux is about 0.4 ms, and may not be a time sufficient for the illuminance sensor 520 to measure light. For example, when the amount of light received by the illuminance sensor 520 (e.g., the light receiving unit 521 of FIG. 5) for the second time is smaller than the threshold amount, the illuminance sensor 520 (e.g., the ADC 522 of FIG. 5) may output the amount of light received through the illuminance sensor 520 as zero. Therefore, when the amount of light incident on the illuminance sensor 520 for the second time (e.g., the amount of light incident on the illuminance sensor 520 and accumulated in the illuminance sensor 520) is smaller than the threshold amount, the illuminance sensor 520 may output a value indicating that light is not received even though the actual amount of light incident on the illuminance sensor 520 is present. On the other hand, the first time (e.g., the long itime) used to calculate the long itime lux is a time in a time range of about 16 ms to 20 ms, and may be a time sufficient for the illuminance sensor 520 to measure light (e.g., a time capable of measuring a relatively correct illuminance value compared to the second time). Accordingly, when the illuminance value by the external light is less than or equal to the threshold illuminance value, the illuminance value measured through the illuminance sensor 520 during the first time is accurately measured, but the illuminance value measured through the illuminance sensor 520 during the second time may not be accurate.

In an embodiment, in reference numeral 1101 and reference numeral 1102, the X axis represents a reference illuminance value (unit: lux) (e.g., the illuminance value measured using advanced equipment that may accurately measure the illuminance value), and the Y axis represents the measured illuminance value (unit: lux) (e.g., the illuminance value measured during the first or second time).

In an embodiment, in reference numeral 1101, the line 1111 and the line 1112, respectively, may indicate the illuminance value measured for the first time compared to the reference illuminance value and the illuminance value measured for the second time compared to the reference illuminance value. In an embodiment, both the illuminance value measured during the first time and the illuminance value measured during the second time may be linear to the reference illuminance value in a range in which the reference illuminance value (e.g., the illuminance value measured using advanced equipment capable of accurately measuring the illuminance value) exceeds about 100 lux, such as the line 1111 and the line 1112 of reference numeral 1101.

In an embodiment, in reference numeral 1102, the line 1111-1 and the line 1112-1, respectively, may indicate the illuminance value measured for the first time compared to the reference illuminance value and the illuminance value measured for the second time compared to the reference illuminance value in a range in which the reference illuminance value is less than or equal to 100 lux. In an embodiment, in a range in which the reference illuminance value is less than or equal to about 100 lux, such as the line 1111-1 and the line 1112-1 of reference numeral 1102, the illuminance value measured during the first time may be linear with respect to the reference illuminance value, while the illuminance value measured during the second time may not be linear with respect to the reference illuminance value. Accordingly, when the illuminance value by the external light measured through the illuminance sensor 520 is less than or equal to the threshold illuminance value (e.g., about 100 lux described above), the accuracy of the correction value determined using the first method may be lowered. In the above-described examples, it has been described that the threshold illuminance value is about 100 lux, but the disclosure is not limited thereto. For example, the threshold illuminance value may be a value different from about 100 lux according to the display 512 and/or illuminance sensor 520.

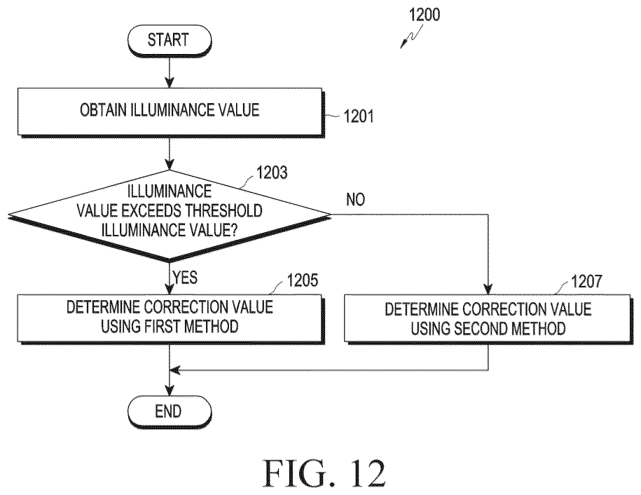

FIG. 12 is a flowchart 1200 illustrating a method for calibrating an illuminance sensor 520 according to an embodiment.

In an embodiment, as described with reference to FIG. 11, when the illuminance value (e.g., short itime min lux) by the external light measured through the illuminance sensor (e.g., the illuminance sensor 520 of FIG. 5) is less than or equal to the threshold illuminance value (e.g., about 100 lux), the accuracy of the correction value determined using the first method may be lowered. FIG. 12 may be an example of an operation of calculating a correction value using a first method or an operation of calculating a correction value using a second method according to an illuminance value by light measured through an illuminance sensor 520.

In the following embodiment, each operation may be sequentially performed, but is not necessarily performed sequentially. For example, the order of the operations may be changed, and at least two operations may be performed in parallel.

According to an embodiment, it may be understood that operations 1201 to 1207 are performed by a processor (e.g., the processor 540 of FIG. 5) of an electronic device (e.g., the electronic device 501 of FIG. 5).

Referring to FIG. 12, in operation 1201, in an embodiment, the processor 540 may obtain the illuminance value (e.g., short itime min lux) based on the illuminance data obtained through the illuminance sensor 520 at each second time (e.g., the short itime) shorter than the first time (e.g., the long itime) while the display (e.g., the display 512 of FIG. 5) is turned on/off.

In an embodiment, the operation in which the processor 540 obtains the illuminance value (short itime min lux) in operation 1201 may be at least partially the same or similar to the operation in which the processor 540 obtains the second illuminance value in operation 603 of FIG. 6. Accordingly, a detailed description of operation 1201 is omitted.

In operations 1203, in an embodiment, the processor 540 may identify whether the illuminance value obtained in operation 1201 exceeds the threshold illuminance value.

In an embodiment, the threshold illuminance value may be the threshold illuminance value (e.g., about 100 lux) described with reference to FIG. 11. In an embodiment, the processor 540 may set the threshold illuminance value differently according to the display 512 and/or the illuminance sensor 520.

In an embodiment, the processor 540 may set the minimum reference illuminance value as the threshold illuminance value in a range of the reference illuminance value in which the illuminance value measured for the second time exhibits linearity with respect to the reference illuminance value (e.g., the reference illuminance value described with reference to FIG. 11). For example, the processor 540 may set the minimum reference illuminance value (e.g., about 100 lux) as the threshold illuminance value in the range of the reference illuminance value (e.g., about 100 lux to about 1000 lux) in which the illuminance value measured for the second time exhibits linearity with respect to the reference illuminance value in reference 1101 and 1102 of FIG. 11.

In operations 1205, in an embodiment, the processor 540 may determine the correction value using the first method based on identifying that the illuminance value (e.g., short itime min lux) exceeds the threshold illuminance value in operation 1203. For example, when the illuminance value (e.g., short itime min lux) obtained through operation 1201 exceeds the threshold illuminance value (e.g., about 100 lux), the processor may determine the correction value using the first method described through FIG. 6.

In operations 1207, in an embodiment, the processor 540 may determine the correction value using the second method based on identifying that the illuminance value (e.g., short itime min lux) is less than or equal to the threshold illuminance value in operation 1203. For example, when the illuminance value obtained through operation 1201 is less than or equal to the threshold illuminance value (e.g., about 100 lux), the processor 540 may determine the correction value using the second method described through FIG. 9.

In the above-described examples, when the illuminance value (e.g., short itime min lux) obtained through operation 1201 is less than or equal to the threshold illuminance value (e.g., about 100 lux), the correction value is determined using the second method, but the disclosure is not limited thereto. For example, when the processor is configured to determine the correction value using the first method, the processor 540 may not perform the operation of determining the correction value using the first method based on the illuminance value (e.g., short itime min lux) obtained through operation 1201 being less than or equal to the threshold illuminance value (e.g., about 100 lux). For example, when the processor is configured to determine the correction value using the first method, the processor 540 may perform the operation of determining the correction value using the first method only when the illuminance value (e.g., short itime min lux) obtained through operation 1201 exceeds the threshold illuminance value (e.g., about 100 lux).

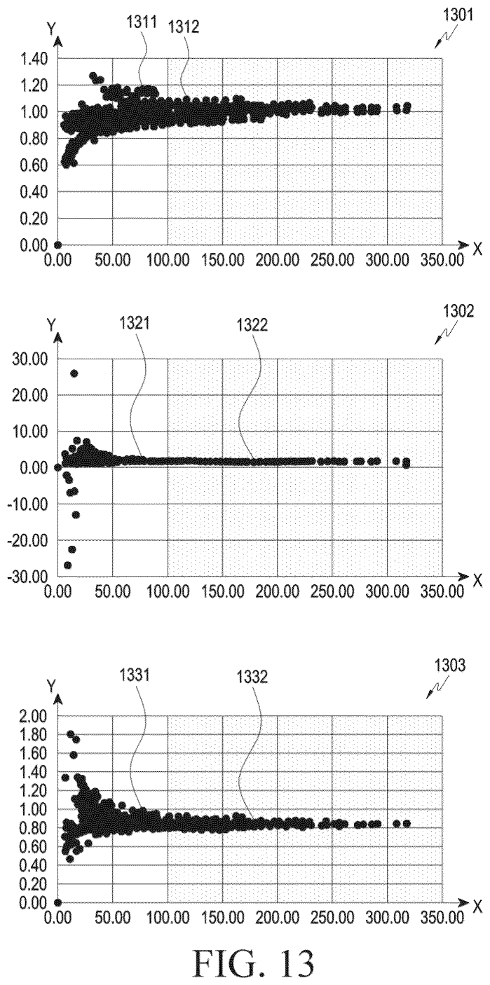

FIG. 13 is a view illustrating a method for calibrating an illuminance sensor 520 according to an embodiment.

Referring to FIG. 13, in an embodiment, when the illuminance value (hereinafter referred to as “COPR illuminance value” or “display light estimation value”) obtained based on the color information about the image and the information related to the luminance of the display is less than or equal to the threshold illuminance value (hereinafter referred to as “threshold illuminance value”) (e.g., about 100 lux), an accurate correction value may not be calculated. In an embodiment, in Equation 4, as the COPR illuminance value decreases, the illuminance value measured through the illuminance sensor by the display light may also increase. As the illuminance value measured through the illuminance sensor by the display light decreases, the minimum unit of the calculated correction value may increase. For example, assuming that the accurately measured correction value (e.g., the correction value calculated by measuring light using advanced equipment) is about 1.384, when the illuminance value measured through the illuminance sensor 520 by the display light is about 100 lux, the correction value is determined to be about 1.38 of the 1/100 unit and, when the illuminance value measured through the illuminance sensor 520 by the display light is about 1000 lux, the correction value may be determined to be about 1.384 of the 1/1000 unit. Accordingly, when the COPR illuminance value is less than or equal to the threshold illuminance value, an accurate correction value may not be calculated.

In an embodiment, when the operation of calculating the correction value using the second method is performed, an accurate correction value may not be calculated when the difference between the illuminance value (hereinafter referred to as “second COPR illuminance value”) obtained based on the color information about the second image and information related to the luminance of the display and the illuminance value (hereinafter referred to as “first COPR illuminance value”) obtained based on the color information about the first image and information related to the luminance of the display is less than or equal to the threshold illuminance value (e.g., about 100 lux).

In an embodiment, in Equation 9, as the difference between the second COPR illuminance value and the first COPR illuminance value decreases, the difference between the second illuminance value measured by the illuminance sensor and the first illuminance value measured by the illuminance sensor may also decrease. As the difference between the second illuminance value measured by the illuminance sensor and the first illuminance value measured by the illuminance sensor decreases, the minimum unit of the calculated correction value may increase, and accordingly, when the difference between the second COPR illuminance value and the first COPR illuminance value is less than or equal to the threshold illuminance value, an accurate correction value may not be calculated.

In an embodiment, reference numeral 1301 may be a graph of a combination between the display and the illuminance sensor (hereinafter referred to as a “first combination” or “typical set”) in which an illuminance value corresponding to an average illuminance value (or a median illuminance value) is measured when measuring the illuminance value in various combinations between displays and illuminance sensors in the dark room condition. Reference numeral 1301 may indicate correction values 1311 and 1312 calculated while changing (e.g., increasing) the luminance code of the display (e.g., while changing the COPR illuminance value) while each of the 14 images with different brightness and colors is displayed through the display in the first combination. In reference numeral 1301, the X axis (unit: lux) may indicate the COPR illuminance value (or a range of COPR illuminance values), and the Y axis may indicate the correction value.

In an embodiment, reference numeral 1302 may be a graph of a combination between the display and the illuminance sensor (hereinafter referred to as a “second combination” or “minimum set”) in which an illuminance value corresponding to the minimum illuminance value is measured when measuring the illuminance value in various combinations between displays and illuminance sensors in the dark room condition. Reference numeral 1302 may indicate correction values 1321 and 1322 calculated while changing (e.g., increasing) the luminance code of the display (e.g., while changing the COPR illuminance value) while each of the 14 images with different brightness and colors is displayed through the display in the second combination. In reference numeral 1302, the X axis (unit: lux) may indicate the COPR illuminance value (or a range of COPR illuminance values), and the Y axis may indicate the correction value.

In an embodiment, reference numeral 1303 may be a graph of a combination between the display and the illuminance sensor (hereinafter referred to as a “third combination” or “maximum set”) in which an illuminance value corresponding to the maximum illuminance value is measured when measuring the illuminance value in various combinations between displays and illuminance sensors in the dark room condition. Reference numeral 1303 may indicate correction values 1331 and 1332 calculated while changing (e.g., increasing) the luminance code of the display (e.g., while changing the COPR illuminance value) while each of the 14 images with different brightness and colors is displayed through the display in the second combination. In reference numeral 1303, the X axis (unit: lux) may indicate the COPR illuminance value (or a range of COPR illuminance values), and the Y axis may indicate the correction value.

In an embodiment, reference numerals 1301, 1302, and 1303 may be shown as illustrated in Table 1 below.

TABLE 1

| | | | | | | 250 or | reference |
|---|---|---|---|---|---|---|---|
| | 0-50 | 50-100 | 100-150 | 150-200 | 200-250 | more | correction value |
| first | 0.90 | 1.00 | 1.00 | 1.02 | 1.02 | 1.02 | 0.99 |
| combination | | | | | | | |
| second | 1.17 | 1.64 | 1.61 | 1.62 | 1.61 | 1.63 | 1.53 |
| combination | | | | | | | |
| third | 0.80 | 0.85 | 0.84 | 0.85 | 0.84 | 0.84 | 0.85 |
| combination | | | | | | | |

In an embodiment, in Table 1, “0-50” may represent a range in which the COPR illumination value is about 0 lux or more and less than about 50 lux, “50-100” may represent a range in which the COPR illumination value is about 50 lux or more and less than about 100 lux, “100-150” may represent a range in which the COPR illumination value is about 100 lux or more and less than about 150 lux, “150-200” may represent a range in which the COPR illumination value is about 150 lux or more and less than about 200 lux, “200-250” may represent a range in which the COPR illumination value is about 200 lux or more and less than about 250 lux, and “250 or more” may represent a range in which the COPR illumination value is about 250 lux or more.

In an embodiment, in Table 1, “0.90”, “1.00”, “1.00”, “1.02”, “1.02”, and “1.02”, corresponding to the first combination, may represent the average correction values measured in the respective ranges of COPR luminance values “0-50”, “50-100”, “100-150”, “150-200”, “200-250”, and “250 or more” in the first combination.

In an embodiment, in Table 1, the reference correction value of 0.99 corresponding to the first combination may represent a calculated correction value while a white image having the maximum brightness is displayed while the luminance of the display 512 is set to the maximum luminance for the first combination in the dark room condition.

In an embodiment, in Table 1, “1.17”, “1.64”, “1.61”, “1.62”, “1.61”, and “1.63”, corresponding to the second combination, may represent the average correction values measured in the respective ranges of COPR luminance values “0-50”, “50-100”, “100-150”, “150-200”, “200-250”, and “250 or more” in the second combination.

In an embodiment, in Table 1, the reference correction value of 1.53 corresponding to the second combination may represent a calculated correction value while a white image having the maximum brightness is displayed while the luminance of the display is set to the maximum luminance for the second combination in the dark room condition.

In an embodiment, in Table 1, “0.80”, “0.85”, “0.84”, “0.85”, “0.84”, and “0.84”, corresponding to the third combination, may represent the average correction values measured in the respective ranges of COPR luminance values “0-50”, “50-100”, “100-150”, “150-200”, “200-250”, and “250 or more” in the second combination.

In an embodiment, in Table 1, the reference correction value of 0.85 corresponding to the third combination may represent a calculated correction value while a white image having the maximum brightness is displayed while the luminance of the display is set to the maximum luminance for the third combination in the dark room condition.

In an embodiment, the ratios of the values obtained by subtracting the reference correction value corresponding to the first combination from each of the correction values corresponding to the first combination with respect to the reference correction value corresponding to the first combination (e.g., (correction value-reference correction value)/(reference correction value)*100), the ratios of the values obtained by subtracting the reference correction value corresponding to the second combination from each of the correction values corresponding to the second combination with respect to the reference correction value corresponding to the second combination, and the ratios of the values obtained by subtracting the reference correction value corresponding to the third combination from each of the correction values corresponding to the third combination with respect to the reference correction value corresponding to the third combination may be as shown in Table 2 below.

TABLE 2

| | | | | | | 250 or |
|---|---|---|---|---|---|---|
| | 0-50 | 50-100 | 100-150 | 150-200 | 200-250 | more |
| first | about −9% | about 1% | about 1% | about 2% | about 3% | about 3% |
| combination | | | | | | |
| second | about −24% | about 7% | about 6% | about 6% | about 5% | about 7% |
| combination | | | | | | |
| third | about −5% | about 0% | about −1% | about 0% | about 0% | about −1% |
| combination | | | | | | |

In an embodiment, the standard deviations of the correction values measured in each of ‘0-50’, ‘50-100’, ‘100-150’, ‘150-200’, ‘200-250’, and ‘250 or more’ in the first combination, the second combination, and the third combination may be as shown in Table 3 below.

TABLE 3

| | | | | | | 250 or |
|---|---|---|---|---|---|---|
| | 0-50 | 50-100 | 100-150 | 150-200 | 200-250 | more |
| first | 0.265 | 0.060 | 0.042 | 0.032 | 0.017 | 0.010 |
| combination | | | | | | |
| second | 2.186 | 0.109 | 0.068 | 0.049 | 0.038 | 0.034 |
| combination | | | | | | |
| third | 0.248 | 0.040 | 0.027 | 0.022 | 0.012 | 0.007 |
| combination | | | | | | |

In an embodiment, the threshold luminance value (e.g., the COPR luminance value compared with the difference between the second COPR illuminance value and the first COPR illuminance value used during the operation for calculating the correction value using the second method and the COPR illuminance value used during the operation for calculating the correction value using the first method) may be set to the minimum COPR luminance value within the range of COPR luminance values where the ratios of the values obtained by subtracting the reference correction value corresponding to each combination (e.g., the first combination, the second combination, and the third combination) from each correction value of each combination for the reference correction value corresponding to each combination are equal to or less than a designated ratio (e.g., about 10%), and the standard deviations of the correction values of each combination are equal to or less than a designated standard deviation. For example, referring to reference numeral 1301, reference numeral 1302, and reference numeral 1303, as well as Table 1, Table 2, and Table 3, about 100 lux which is the minimum COPR illuminance value in the range of the COPR illuminance values which are about 100 lux or more, in which the ratios of the values obtained by subtracting the reference correction value corresponding to each combination from each of the correction values of each combination may be equal to or less than the designated ratio (e.g., about 10%), and the standard deviations of the correction values of each combination may be equal to or less than the designated standard deviation, may be set as the threshold illuminance value.

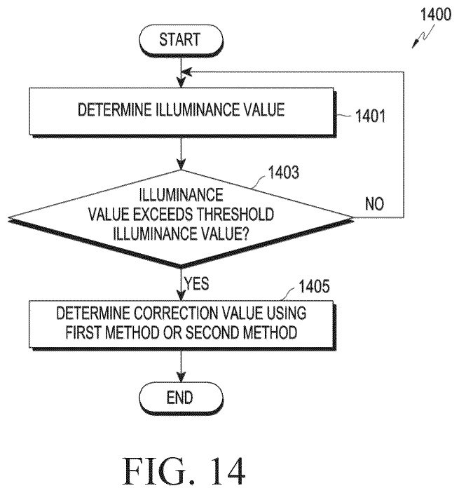

FIG. 14 is a flowchart 1400 illustrating a method for calibrating an illuminance sensor 520 according to an embodiment.

In an embodiment, when the threshold illuminance value is less than or equal to the COPR illuminance value used in the operation of calculating the correction value using the first method, or when the difference between the second COPR illuminance value and the first COPR illuminance value used in the operation of calculating the correction value using the second method is less than or equal to the threshold illuminance value, an accurate correction value may not be calculated. FIG. 14 may be a view illustrating operations performed by the processor 540 when the threshold illuminance value is less than or equal to the COPR illuminance value used in the operation of calculating the correction value using the first method, or when the difference between the second COPR illuminance value and the first COPR illuminance value, used in the operation of calculating the correction value using the second method, is less than or equal to the threshold illuminance value.

In the following embodiment, each operation may be sequentially performed, but is not necessarily performed sequentially. For example, the order of the operations may be changed, and at least two operations may be performed in parallel.

According to an embodiment, operations 1401 to 1405 may be understood to be performed by the processor (e.g., the processor 540 of FIG. 5) of the electronic device (e.g., the electronic device 501 of FIG. 5).

In operations 1401, in an embodiment, the processor 540 may determine an illuminance value (display light estimation value) (e.g., a COPR illuminance value) while an image is displayed through the display (e.g., the display 512 of FIG. 5). For example, when the processor 540 is configured to calculate the correction value using the first method, the processor 540 may determine the COPR illuminance value of the image displayed through the display 512. For example, when the processor 540 is configured to calculate the correction value using the second method, the difference between the second COPR illuminance value of the second image and the first COPR illuminance value of the first image may be determined while the first image and the second image are sequentially displayed through the display 512.

In operations 1403, in an embodiment, the processor 540 may identify whether the illuminance value (display light estimation value) determined in operation 1401 exceeds the threshold illuminance value. For example, when the processor 540 is configured to calculate the correction value using the first method, it may determine whether the COPR illuminance value of the image displayed through the display 512 exceeds the threshold illuminance value. For example, when the processor 540 is configured to calculate the correction value using the second method, the difference between the second COPR illuminance value of the second image and the first COPR illuminance value of the first image may exceed the threshold illuminance value.

In operations 1403, in an embodiment, the processor 540 may perform operation 1401 without performing an operation of determining the correction value based on identifying that the illuminance value (display light estimation value) determined in operation 1401 is less than or equal to the threshold illuminance value.

In operations 1403, in an embodiment, the processor 540 may perform the operation of determining the correction value by the set first method or second method based on identifying that the illuminance value (display light estimation value) determined in operation 1401 exceeds the threshold illuminance value.

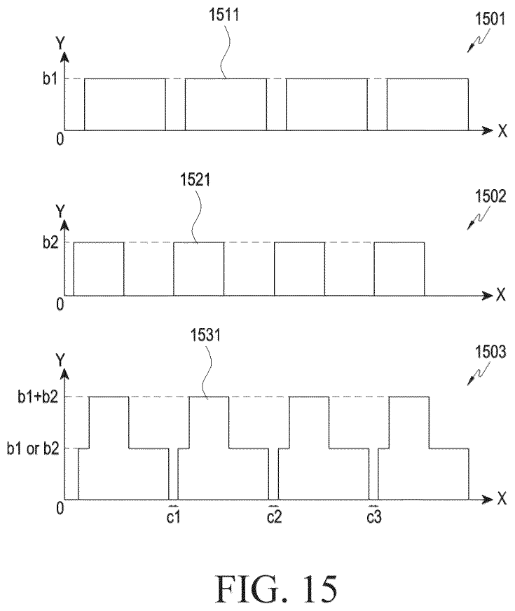

FIG. 15 is a view illustrating an illuminance value obtained by an illuminance sensor 520 when a light source is a flicker light source, according to an embodiment.

Referring to FIG. 15, in an embodiment, when the illuminance sensor (e.g., the illuminance sensor 520 of FIG. 5) receives sunlight as external light, the illuminance sensor 520 may obtain the illuminance value having a substantially constant value (e.g., having a constant value) by sunlight as external light. On the other hand, when the light received by the illuminance sensor 520 is light emitted from a flicker light source that is periodically blinking (e.g., periodically on/off), the illuminance value obtained through the illuminance sensor 520 may not be constant.

In an embodiment, in reference numeral 1501, the X axis may indicate time and the Y axis may indicate the illuminance value (unit: lux). Reference numeral 1501 may indicate the illuminance value 1511 measured by the light emitted from a display (e.g., the display 512 of FIG. 5) driven by a PWM method over time (e.g., X-axis). For example, the illuminance value measured when the display 512 is in the on state may be b1, and the illuminance value measured when the display 512 is in the off state may be substantially zero.

In an embodiment, in reference numeral 1502, the X axis may indicate time and the Y axis may indicate the illuminance value (unit: lux). Reference numeral 1502 may indicate the illuminance value 1521 measured by the light emitted from the flicker light source over time. For example, the illuminance value measured when the flicker light source is in the on state may be b2, and the illuminance value measured when the flicker light source is in the off state may be substantially zero.

In an embodiment, as illustrated in reference numeral 1501, 1502, the period when the display 512 is turned on/off and the period when the flicker light source is turned on/off may be different. In an embodiment, reference numeral 1503 may indicate the illuminance value 1531 measured by the light emitted from the display 512 and the light emitted from the flicker light source.

In an embodiment, in reference numeral 1503, the X axis may indicate time and the Y axis may indicate the illuminance value (unit: lux). As illustrated in reference numeral 1503, since the period when the display 512 is turned on/off and the period when the flicker light source is turned on/off are different, the measured illuminance value in predetermined time intervals (e.g., the time intervals c1, c2, and c3) may be substantially 0 lux. In this case, under the condition (or environment) that the light source is the flicker light source, the short itime min lux used to calculate the correction value using the first method may be determined to be substantially 0 lux, so the exact correction value may not be determined.

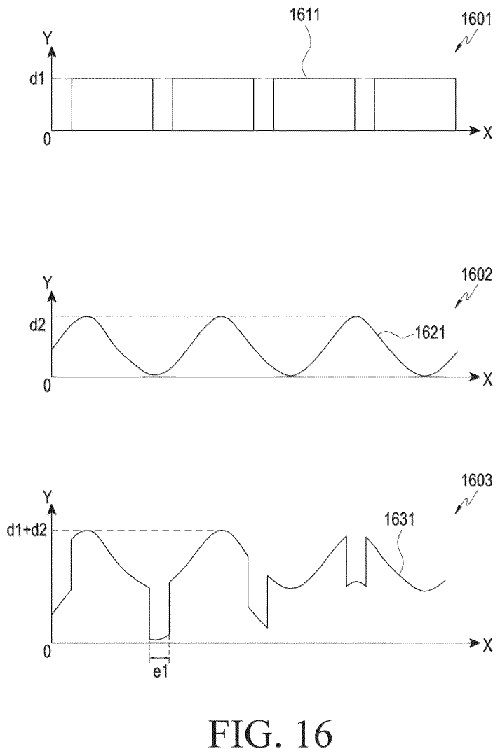

FIG. 16 is a view illustrating an illuminance value obtained by an illuminance sensor 520 when a light source is a light source having a form in which the intensity of light varies, according to an embodiment.

Referring to FIG. 16, in an embodiment, when the illuminance sensor (e.g., the illuminance sensor 520 of FIG. 5) receives sunlight as external light, the illuminance sensor 520 may obtain the illuminance value having a substantially constant value (e.g., having a constant value) by sunlight as external light. On the other hand, when the light received by the illuminance sensor 520 is light emitted from a light source (hereinafter referred to as a “first light source”) that emits light with a varying intensity of light (e.g., a sinusoidal form), the illuminance value obtained through the illuminance sensor 520 may not be constant.

In an embodiment, in reference numeral 1601, the X axis may indicate time and the Y axis may indicate the illuminance value (unit: lux). Reference numeral 1601 may indicate the illuminance value 1611 measured by the light emitted from the display 512 driven by the PWM method over time. For example, the illuminance value measured when the display (e.g., the display 512 in FIG. 5) is in the on state may be d1, and the illuminance value measured when the display 512 is in the off state may be substantially zero.

In an embodiment, in reference numeral 1602, the X axis may indicate time and the Y axis may indicate the illuminance value (unit: lux). Reference numeral 1602 may indicate the illuminance value 1621 measured by light (e.g., a sine wave-type light source) emitted from the first light source over time. For example, the maximum illuminance value measured by the light emitted from the first light source may be d2, and the minimum illuminance value may be substantially 0.

In an embodiment, reference numeral 1603 may indicate the illuminance value 1631 measured by the light emitted from the display 512 and the light emitted from the first light source.

In an embodiment, in reference numeral 1603, the X axis may indicate time and the Y axis may indicate the illuminance value (unit: lux). As illustrated in reference numeral 1603, since the period when the display 512 is turned on/off and the period of the first light source are different, the illuminance value measured in a predetermined time interval (e.g., the time interval e1) may be smaller than the short itime min lux used when calculating the correction value using the first method when the sunlight is external light.

In an embodiment, Table 4 below may represent the correction value determined using the first method when the external light is sunlight, when the light source is the first light source.

TABLE 4

| | when the | when the | |
|---|---|---|---|
| | external light is | light source is the | |
| | sunlight | first light source | |
| long itime lux | 300 lux | 300 | lux |
| short itime min lux | 100 lux | 0 | lux |
| difference between long | 200 lux | 300 | lux |

| | | |
|---|---|---|
| itime lux and short itime min | | |
| lux | | |
| COPR illuminance value | 150 | 150 |
| correction value | 0.75 | 0.5 |

In an embodiment, in Table 4, the COPR illuminance value determined by the light of the display 512 may be about 150 lux, and long itime lux may be about 300 lux which is the same when the external light is sunlight and when the light source is the first light source. In this case, the short itime min lux may be about 0 lux when the light source is the first light source, and may be smaller than about 100 lux which is measured when the external light is sunlight. Accordingly, using Equation 4, about 0.5 which is the correction value determined using the first method when the light source is the first light source may be smaller than about 0.75 which is the correction value determined using the first method when the external light is sunlight.

In an embodiment, Table 4 illustrates a case where the light source is the first light source, but similarly may be applied even when the light source is a flicker light source as illustrated in FIG. 15. For example, when the light source is a flicker light source, the correction value determined using the first method may be smaller than the correction value determined using the first method when the external light is sunlight.

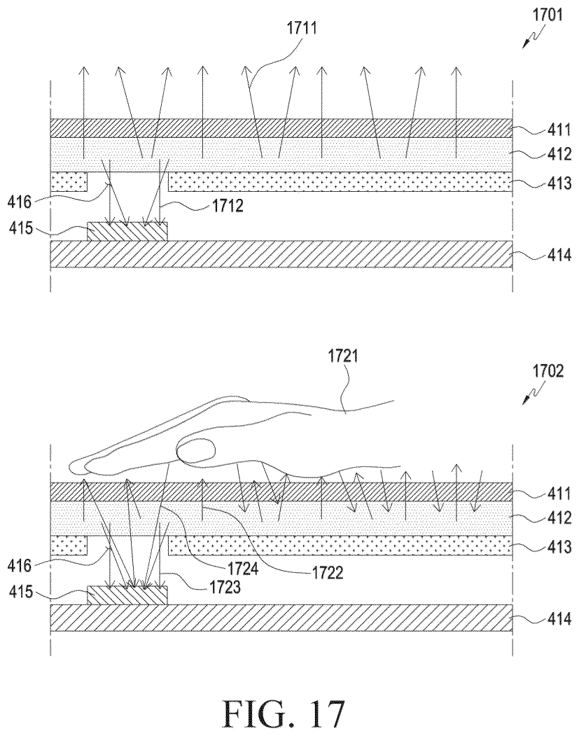

FIG. 17 is a view illustrating an illuminance value obtained by an illuminance sensor 520 when the illuminance sensor 520 is obscured by an object, according to an embodiment.

Referring to FIG. 17, in an embodiment, reference numeral 1701 may indicate light incident on the illuminance sensor 415 when illuminance sensor 415 (e.g., the illuminance sensor 520 of FIG. 5) is not obscured by an object (e.g., the user's hand 1721). For example, when the illuminance sensor 415 is not obscured by an object, the light emitted through the display 412 (e.g., the display 512 of FIG. 5) may include light emitted to the outside and light 1712 incident on the illuminance sensor 415.

In an embodiment, reference numeral 1702 may indicate light incident on the illuminance sensor 415 when the illuminance sensor 415 is obscured by an object (e.g., the user's hand 1721). For example, when the illuminance sensor 415 is obstructed by an object, the illuminance sensor 415 may receive, in addition to the light emitted from the display 412 and directly incident on the illuminance sensor 415, a portion 1724 (e.g., the light diffused by the hand 1721) of the light (e.g., the light 1722) emitted through the display 412. Accordingly, when the illuminance sensor 415 is obscured by an object, the illuminance value (long itime lux) measured by the display light may be larger than the illuminance value measured by the display light when the illuminance sensor 415 is not obscured by the object. In this case, in both the case of determining the correction value using the first method and the case of determining the correction value using the second method, the correction value determined when the illuminance sensor 415 is obscured by the object may be smaller than the correction value determined when the illuminance sensor 415 is not obscured by the object. For example, Table 5 below may represent the correction value determined using the second method (e.g., using Equation 9) when the illuminance sensor 415 is not obscured by an object and when the illuminance sensor 415 is obscured by an object.

TABLE 5

| | when the light | when the light |
|---|---|---|
| | sensor is not | sensor is |
| | obscured by | obscured by |
| | an object | an object |
| first illuminance value | 200 | 360 |
| measured by the illuminance | | |
| sensor | | |
| second illuminance value | 400 | 720 |
| measured by the illuminance | | |
| sensor | | |
| difference between second | 200 | 360 |
| illuminance value and first | | |
| illuminance value | | |
| second COPR illuminance | 150 | 150 |
| value | | |
| first COPR illuminance value | 300 | 300 |
| difference between second | 150 | 150 |
| COPR illuminance value and | | |
| first COPR illuminance value | | |
| correction value | 0.75 | 0.42 |

In an embodiment, as illustrated in Table 5, the correction value of about 0.42 determined when the illuminance sensor 415 is obscured by an object may be smaller than about 0.75 determined when the illuminance sensor 415 is not obscured by an object.

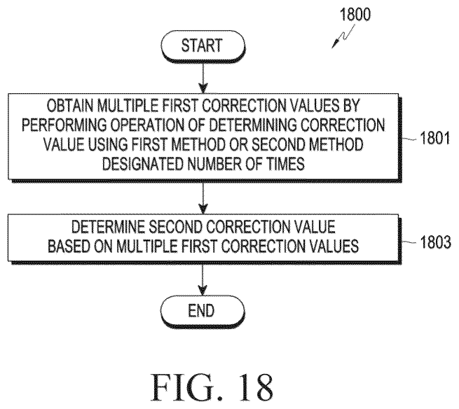

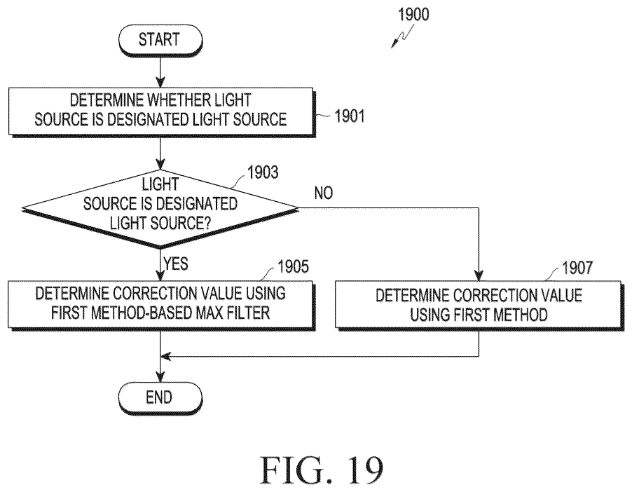

In an embodiment, as described through FIG. 15 and FIG. 16, the correction value determined using the first method when the light source is a flicker light source or the light source is the first light source may be smaller than the correction value determined using the first method when the external light is sunlight. Further, when the illuminance sensor 415 is obscured by an object, the correction value determined using the first method or the second method may be smaller than the correction value determined using the first method or the second method when the illuminance sensor 415 is not obscured by an object. Hereinafter, a method for determining a more accurate correction value when the light source is a flicker light source, when the light source is the first light source, or when the illuminance sensor 415 is obscured by an object is described with reference to FIGS. 18 and 19.

FIG. 18 is a flowchart 1800 illustrating a method for calibrating an illuminance sensor 520 according to an embodiment.

In the following embodiment, each operation may be sequentially performed, but is not necessarily performed sequentially. For example, the order of the operations may be changed, and at least two operations may be performed in parallel.

According to an embodiment, operations 1801 to 1805 may be understood to be performed by the processor (e.g., the processor 540 of FIG. 5) of the electronic device (e.g., the electronic device 501 of FIG. 5).

Referring to FIG. 18, in operation 1801, in an embodiment, the processor 540 may obtain a plurality of first correction values by performing the operation of determining the correction value using the first method or the second method a designated number of times.

In an embodiment, the processor 540 may obtain a plurality of first correction values by repeatedly performing the operation of determining the correction value using the first method a designated number of times. For example, the processor 540 may obtain 10 first correction values by repeatedly performing operations 601 to 609 of FIG. 6 10 times as the designated number of times.

In an embodiment, whenever the display (e.g., the display 512 of FIG. 5) is switched from the off state (e.g., an inactive state) to the on state (e.g., an active state) by a user input or a designated setting, the processor 540 may perform the operation of determining the correction value using the first method once. For example, when the display 512 is turned on by inputting an input to turn on (e.g., power on) the display 512, the processor 540 may perform the operation of determining the correction value using the first method once. When the display 512 is turned on 10 times, the processor 540 may obtain 10 first correction values by performing the operation of determining the correction value 10 times using the first method. However, the disclosure is not limited thereto. For example, the processor 540 may obtain a plurality of first correction values by repeatedly performing the operation of determining the correction value using the first method once every designated time period.

In an embodiment, the processor 540 may obtain a plurality of first correction values by repeatedly performing the operation of determining the correction value using the second method a designated number of times. For example, the processor 540 may obtain 10 first correction values by repeatedly performing operations 901 to 905 of FIG. 9 10 times as the designated number of times.

In an embodiment, whenever the image displayed through the display 512 is changed, the processor 540 may perform the operation of determining the correction value using the second method once. For example, when the image displayed through the display 512 is changed from the first image to the second image, the processor 540 may perform the operation of determining the correction value using the second method once. As such, the processor 540 may obtain 10 first correction values by performing the operation of determining the correction value using the second method 10 times when the image displayed through the display 512 is changed 10 times.

In an embodiment, the processor 540 may determine the correction values obtained by performing the operation of determining the correction value using the first method or the second method a designated number of times most recently from the current time as a plurality of first correction values. For example, when the designated number of times is 10 times, the processor 540 may determine the correction value obtained by the operation of determining the correction value, most recently performed, and nine correction values obtained by performing the operations of determining the correction value nine times before the operation of determining the correction value, most recently performed, as the plurality of first correction values.

In operations 1803, in an embodiment, the processor 540 may determine a second correction value (e.g., the final correction value) (hereinafter referred to as a “second correction value”) based on the plurality of first correction values. For example, the processor 540 may determine the maximum value (e.g., the second correction value) among the plurality of first correction values as the final correction value.

As described through FIG. 15 to FIG. 17, the correction value determined using the first method when the light source is a flicker light source or the light source is the first light source may be smaller than the correction value determined using the first method when the external light is sunlight. Further, when the illuminance sensor 520 is obscured by an object, the correction value determined using the first method or the second method may be smaller than the correction value determined using the first method or the second method when the illuminance sensor 520 is not obscured by an object.

In an embodiment, the operation of determining the correction value performed while the user uses the electronic device 501 may be performed in the environment in which the light source is the flicker light source (or the first light source) or the environment in which external light is sunlight. By performing the operation of determining the correction value a plurality of times (e.g., a designated number of times), the operation of determining the correction value in the environment in which external light is sunlight may be performed one or more times among the plurality of times.

In an embodiment, the operation of determining the correction value performed in a state in which the user uses the electronic device 501 may be performed in a state in which the illuminance sensor 520 is obscured by an object or the illuminance sensor 520 is not obscured by an object. By performing the operation of determining the correction value a plurality of times (e.g., the designated number of times), the operation of determining the correction value in a state in which the illuminance sensor 520 is not obscured by an object may be performed at least once among the plurality of times.

In an embodiment, the maximum value (second correction value) among the plurality of first correction values may be a correction value calculated by performing the operation of determining the correction value in the environment in which external light is sunlight. For example, the plurality of first correction values may be obtained by performing operations that determine the first correction value in the environment in which the light source is the flicker light source (or the light source is the first light source) or in the environment in which the external light is sunlight. The first correction value calculated by performing the operation of determining the first correction value in the environment in which external light is sunlight may be a value larger than the first correction value calculated by performing the operation of determining the first correction value in the environment in which the light source is the flicker light source (or the light source is the first light source). The maximum value (second correction value) among the plurality of first correction values may be a correction value calculated by performing the operation of determining the correction value in the environment in which external light is sunlight. For example, the maximum value (second correction value) among the plurality of first correction values may be a correction value calculated by performing the operation of determining the correction value in the environment in which external light is sunlight. For example, the larger value among the plurality of first correction values may be more likely to correspond to the correction value calculated by performing the operation of determining the correction value in the environment in which external light is sunlight. Accordingly, the processor 540 may determine the maximum value among the plurality of first correction values as the second correction value.

In an embodiment, the maximum value among the plurality of first correction values may be a correction value calculated by performing the operation of determining the correction value in a state in which the illuminance sensor 520 is not obscured by an object. For example, the plurality of first correction values may be obtained by performing, a designated number of times, the operations that determine the first correction value in a state in which the illuminance sensor 520 is obscured by an object or the illuminance sensor 520 is not obscured by an object. The first correction value calculated by performing the operation of determining the first correction value in a state in which the illuminance sensor 520 is not obscured by an object may be a value larger than the first correction value calculated by performing the operation of determining the first correction value in a state in which the illuminance sensor 520 is obscured by an object. The maximum value among the plurality of first correction values may be a correction value calculated by performing the operation of determining the correction value in a state in which the illuminance sensor 520 is not obscured by an object. For example, the maximum value (second correction value) among the plurality of first correction values may be a correction value calculated by performing the operation of determining the correction value in a state in which the illumination sensor 520 is not obstructed by an object. For example, the larger value among the plurality of first correction values may be more likely to correspond to the correction value calculated by performing the operation of determining the correction value in a state in which the illuminance sensor 520 is not obscured by an object. Accordingly, the processor 540 may determine the maximum value among the plurality of first correction values as the second correction value.

In an embodiment, the processor 540 may repeatedly perform the operation of FIG. 18 (e.g., the operation of determining the second correction value by performing the operation of determining the correction value using the first method or the second method) (hereinafter, referred to as an ‘operation for determining the second correction value’). For example, the processor 540 may perform the operation of determining the second correction value based on the first correction values obtained by performing the operation of determining the correction value using the first method or second method a designated number of times most recently from the current time, whenever a designated condition is met (e.g., when the display (e.g., the display 512 of FIG. 5) is switched from the off state (e.g., inactive state) to the on state (e.g., active state), and/or when the image displayed through the display 512 is changed).

In an embodiment, the processor 540 may determine (e.g., update) the currently determined second correction value as the final correction value when the currently determined second correction value is larger than the second correction value previously determined as the final correction value while repeatedly performing the operation for determining the second correction value. In an embodiment, while repeatedly performing the operation for determining the second correction value, the processor 540 may maintain the second correction value previously determined as the final correction value as the final correction value when the currently determined second correction value is less than or equal to the second correction value determined as the final correction value.

In an embodiment, because the environment in which the user uses the electronic device 501 and the darkroom environment are different, there may be a difference between the correction value calculated by performing calibration on the illuminance sensor while the user uses the electronic device 501 (e.g., the second correction value determined by performing operation 1803) and the correction value calculated by performing calibration on the illuminance sensor in the darkroom environment. Accordingly, after the second correction value is determined, the processor 540 may perform the operation of adjusting the second correction value to compensate for the difference.

In an embodiment, the processor 540 may determine the final correction value by calculating (e.g., multiplying) the second correction value with a designated ratio to compensate for the difference. The designated ratio calculated (e.g., multiplied) with the second correction value may be a value determined by an experiment (or test).

In an embodiment, Table 6 below may represent correction values calculated using the method described through FIG. 18, according to the ranges of COPR illuminance values in the first combination, the second combination, and the third combination.

TABLE 6

| | | 100-150 | 150-200 | 200-250 | 250 or more |
|---|---|---|---|---|---|
| first | MAX | 1.10 | 1.10 | 1.06 | 1.04 |
| combination | MAX*0.9 | 0.99 | 0.99 | 0.95 | 0.94 |
| second | MAX | 1.77 | 1.77 | 1.69 | 1.67 |
| combination | MAX*0.9 | 1.60 | 1.59 | 1.52 | 1.50 |
| third | MAX | 0.93 | 0.93 | 0.88 | 0.85 |
| combination | MAX*0.9 | 0.84 | 0.85 | 0.79 | 0.77 |

In an embodiment, in Table 6, “100-150” may represent a range in which the COPR illumination value is about 100 lux or more and less than about 150 lux, “150-200” may represent a range in which the COPR illumination value is about 150 lux or more and less than about 200 lux, “200-250” may represent a range in which the COPR illumination value is about 200 lux or more and less than about 250 lux, and “250 or more” may represent a range in which the COPR illumination value is about 250 lux or more.

In an embodiment, in Table 6, the MAXs corresponding to the first combination, ‘1.10,’ ‘1.10,’ ‘1.06,’ and ‘1.04,’ respectively, may represent the correction values (e.g., the plurality of second correction values) calculated using the method described through FIG. 18 in the ranges of the plurality of COPR illuminance values.

In an embodiment, in Table 6, 0.9 may represent the designated ratio. In Table 6, MAX*0.9 (0.99, 0.99, 0.95, and 0.94) corresponding to the first combination may be values obtained by multiplying the MAXs corresponding to the first combination by 0.9.

In an embodiment, in Table 6, the MAXs corresponding to the second combination, ‘1.77,’ ‘1.77,’ ‘1.69,’ and ‘1.67,’ respectively, may represent the correction values (e.g., the plurality of second correction values) calculated using the method described through FIG. 18 in the ranges of the plurality of COPR illuminance values.

In an embodiment, in Table 6, MAX*0.9 (1.60, 1.59, 1.52, and 1.50) corresponding to the second combination may be values obtained by multiplying the MAXs corresponding to the second combination by 0.9.

In an embodiment, in Table 6, the MAXs corresponding to the third combination, ‘0.93,’ ‘0.93,’ ‘0.88,’ and ‘0.85,’ respectively, may represent the correction values (e.g., the plurality of second correction values) calculated using the method described through FIG. 18 in the ranges of the plurality of COPR illuminance values.

In an embodiment, in Table 6, MAX*0.9 (0.84, 0.84, 0.79, and 0.77) corresponding to the third combination may be values obtained by multiplying the MAXs corresponding to the third combination by 0.9.

In an embodiment, in Table 6, MAX*0.9 corresponding to the first combination, the second combination, and the third combination may be values in which the differences from correction values calculated in the first combination, the second combination, and the third combination in the dark room environment is less than or equal to a designated difference.

FIG. 19 is a flowchart 1900 illustrating a method for calibrating an illuminance sensor 520 according to an embodiment.

In the following embodiment, each operation may be sequentially performed, but is not necessarily performed sequentially. For example, the order of the operations may be changed, and at least two operations may be performed in parallel.

According to an embodiment, it may be understood that operations 1901 to 1907 are performed by a processor (e.g., the processor 540 of FIG. 5) of an electronic device (e.g., the electronic device 501 of FIG. 5).

Referring to FIG. 19, in operation 1901, in an embodiment, the processor 540 may determine whether the light source is a designated light source. For example, the processor 540 may determine whether the light source is a flicker light source or a first light source (e.g., a light source emitting light with a varying intensity of light), or whether the external light is sunlight.

In an embodiment, the processor 540 may determine whether the light source is the designated light source by obtaining a short itime min lux. For example, the processor 540 may obtain a short itime min lux through the illuminance sensor (e.g., the illuminance center 520 of FIG. 5) by the operation described through operation 603 of FIG. 6. The processor 540 may compare the obtained short itime min lux with a designated illuminance value (e.g., the short itime min lux obtained through the illuminance sensor 520 when the external light is sunlight, and stored in the memory (e.g., the memory 530 of FIG. 5)). When the obtained short itime min lux is less than the designated illuminance value, the processor 540 may determine that the light source is the designated light source. When the obtained short itime min lux is more than or equal to the designated illuminance value, the processor 540 may determine that the external light is sunlight. For example, the processor 540 may obtain a plurality of illuminance values based on the illuminance data obtained through the illuminance sensor 520 at each second time shorter than the first time while the display (e.g., the display 512 of FIG. 5) is turned on/off. The processor 540 may determine whether the light source is the designated light source based on the waveform (or frequency) indicated by the plurality of obtained illuminance values.

When it is determined in operation 1903 that the light source is the designated light source, in operation 1905, in an embodiment, the processor 540 may determine the correction value using the first method-based max filter. For example, as described through FIG. 18, the processor 540 may determine the final correction value by performing the operation of obtaining the plurality of first correction values and the operation of determining the second correction value based on the plurality of first correction values by performing the operation of determining the correction value using the first method a designated number of times.

However, the disclosure is not limited thereto. For example, when it is determined that the light source is the designated light source, the processor 540 may determine the correction value using the second method. For example, when it is determined that the light source is the designated light source, the processor 540 may determine the correction value using the second method-based max filter. As described through FIG. 18, the processor 540 may determine the final correction value by performing the operation of obtaining the plurality of first correction values and the operation of determining the second correction value based on the plurality of first correction values by performing the operation of determining the correction value using the second method a designated number of times.

When it is determined in operation 1903 that the light source is not the designated light source, in operation 1907, in an embodiment, the processor 540 may determine the correction value using the first method. For example, when the external light is sunlight, the processor 540 may determine the correction value using the first method.

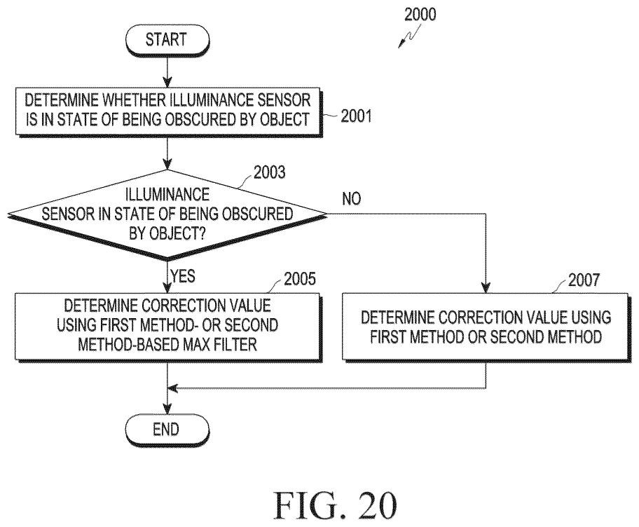

FIG. 20 is a flowchart 2000 illustrating a method for calibrating an illuminance sensor 520 according to an embodiment.

In the following embodiment, each operation may be sequentially performed, but is not necessarily performed sequentially. For example, the order of the operations may be changed, and at least two operations may be performed in parallel.

According to an embodiment, it may be understood that operations 2001 to 2007 are performed by a processor (e.g., the processor 540 of FIG. 5) of an electronic device (e.g., the electronic device 501 of FIG. 5).

Referring to FIG. 20, in operation 2001, in an embodiment, the processor 540 may determine whether the illuminance sensor 520 is in a state of being obscured by an object. For example, the processor 540 may determine that the illuminance sensor 520 is in a state of being obscured by the object when the user's finger touches the first area of the display 512 or hovers to obscure the illuminance sensor (e.g., the illuminance sensor 520 of FIG. 5) on the first area of the display (e.g., the display 512 of FIG. 5) using a touch sensor. For example, the processor 540 may determine that the illuminance sensor 520 is in a state of being obscured by an object when the user's finger is close to the first area of the display 512 to obscure the illuminance sensor 520, using a sensor (e.g., a proximity sensor or a time of flight (TOF) module). However, a method for determining whether the illuminance sensor 520 is in a state of being obscured by an object is not limited to the above-described examples.

When it is determined in operation 2003 that the illuminance sensor 520 is in a state of being obscured by an object, in operation 2005, in an embodiment, the processor 540 may determine the correction value using the first method-based or second method-based max filter.

In an embodiment, when it is determined that the illuminance sensor 520 is in a state of being obscured by an object, the processor 540 may determine the correction value using the first method-based max filter. For example, as described through FIG. 18, the processor 540 may determine the final correction value by performing the operation of obtaining the plurality of first correction values and the operation of determining the second correction value based on the plurality of first correction values by performing the operation of determining the correction value using the first method a designated number of times.

In an embodiment, when it is determined that the illuminance sensor 520 is in a state of being obscured by an object, the processor 540 may determine the correction value using the second method-based max filter. For example, as described through FIG. 18, the processor 540 may determine the final correction value by performing the operation of obtaining the plurality of first correction values and the operation of determining the second correction value based on the plurality of first correction values by performing the operation of determining the correction value using the second method a designated number of times.

When it is determined in operation 2003 that the illuminance sensor 520 is in a state of being not obscured by an object, in operation 2007, in an embodiment, the processor 540 may determine the correction value using the first method or the second method.

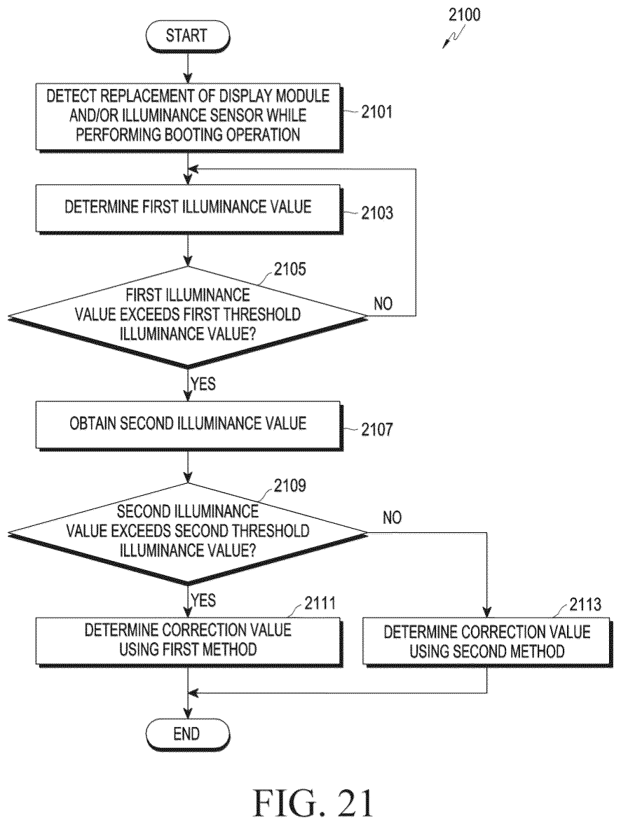

FIG. 21 is a flowchart 2100 illustrating a method for calibrating an illuminance sensor 520 according to an embodiment.

In the following embodiment, each operation may be sequentially performed, but is not necessarily performed sequentially. For example, the order of the operations may be changed, and at least two operations may be performed in parallel.

According to an embodiment, it may be understood that operations 2101 to 2113 are performed by a processor (e.g., the processor 540 of FIG. 5) of an electronic device (e.g., the electronic device 501 of FIG. 5).

Referring to FIG. 21, in operation 2101, in an embodiment, the processor 540 may detect that the display module (e.g., the display module 510 of FIG. 5) and/or the illuminance sensor (e.g., the illuminance sensor 520 of FIG. 5) is replaced while the booting operation is performed. For example, the processor 540 may compare the identification (ID) of the display module 510 and/or the illuminance sensor 520 stored in the memory (e.g., the memory 530 of FIG. 5) before replacing the display module 510 and/or the illuminance sensor 520 while the electronic device 501 is performing a booting operation, and the identification of the display module 510 and/or the illuminance sensor 520 currently mounted in the electronic device 501. When the identification of the display module 510 stored in the memory 530 and the identification of the display module 510 currently mounted in the electronic device 501 are different, or when the identification of the illuminance sensor 520 stored in the memory 530 and the identification of the illuminance sensor 520 currently mounted in the electronic device 501 are different, the processor 540 may determine that the display module 510 and/or the illuminance sensor 520 has been replaced.

In operations 2103, in an embodiment, the processor 540 may determine the first illuminance value (e.g., the fourth illuminance value determined through operation 607 of FIG. 6) based on the color information about the image displayed through the display 512 and information related to the luminance of the display 512 based on determining that the display module 510 and/or the illuminance sensor 520 is replaced. For example, the processor 540 may determine the COPR illuminance value of the image displayed through the display 512 based on determining that display module 510 and/or illuminance sensor 520 is replaced.

In operations 2105, in an embodiment, the processor 540 may determine whether the first illuminance value (display light estimation value) determined in operation 2103 exceeds the first threshold illuminance value (e.g., the threshold illuminance value described through operation 1403 of FIG. 14) (e.g., about 100 lux).

When the first illuminance value (display light estimation value) is less than or equal to the first threshold illuminance value in operations 2105, in an embodiment, the processor 540 may perform operation 2103.

When the first illuminance value (display light estimation value) exceeds the first threshold illuminance value in operations 2105, in operations 2107, in an embodiment, the processor 540 may obtain a second illuminance value (short itime min lux) (e.g., the second illuminance value in operation 603 of FIG. 6) based on the illuminance data obtained through the illuminance sensor 520 at every second time shorter than the first time while the display 512 is turned on/off.

In operation 2109, in an embodiment, the processor 540 may identify whether the second illuminance value (short itime min lux) exceeds the second threshold illuminance value. For example, the processor 540 may determine whether the second illuminance value (short itime min lux) exceeds the threshold illuminance value (e.g., about 100 lux) described through operation 1203 of FIGS. 11 and 12, as the second threshold illuminance value.

When it is identified in operation 2109 that the second illuminance value (short itime min lux) exceeds the second threshold illuminance value, in operation 2111, in an embodiment, the processor 540 may determine the correction value using the first method.

When it is identified in operation 2109 that the second illuminance value (short itime min lux) is less than or equal to the second threshold illuminance value, in operation 2113, in an embodiment, the processor 540 may determine the correction value using the second method.

An electronic device 501 according to an embodiment may comprise a display 512, a light sensor 520 disposed under at least a partial area of the display 512, at least one processor 540, and memory 530 storing instructions. The instructions may, when executed by the at least one processor 540 individually or collectively, cause the electronic device 501 to obtain a first illuminance value based on illuminance data obtained through the light sensor 520 for a first time while the display 512 is turned on/off. The instructions may, when executed by the at least one processor 540 individually or collectively, cause the electronic device 501 to obtain a second illuminance value based on illuminance data obtained through the light sensor 520 at each second time shorter than the first time while the display 512 is turned on/off. The instructions may, when executed by the at least one processor 540 individually or collectively, cause the electronic device 501 to determine a third illuminance value related to light emitted from the display 512, based on the first illuminance value and the second illuminance value. The instructions may, when executed by the at least one processor 540 individually or collectively, cause the electronic device 501 to determine a fourth illuminance value based on color information about an image displayed through the display 512 and information related to a luminance of the display 512. The instructions may, when executed by the at least one processor 540 individually or collectively, cause the electronic device 501 to determine a correction value for correcting an illuminance value obtained through the light sensor 520, based on the third illuminance value and the fourth illuminance value.

In an embodiment, the instructions may, when executed by the at least one processor 540 individually or collectively, cause the electronic device 501 to obtain a plurality of illuminance values based on the illuminance data obtained through the light sensor 520 at each second time, and determine, as the second illuminance value, a minimum value among the plurality of illuminance values.

In an embodiment, the instructions may, when executed by the at least one processor 540 individually or collectively, cause the electronic device 501 to perform determining the correction value based on the second illuminance value exceeding a first threshold illuminance value.

In an embodiment, the instructions may, when executed by the at least one processor 540 individually or collectively, cause the electronic device 501 to, based on the second illuminance value being equal to or less than a first threshold illuminance value determine a third illuminance value based on color information about a first image displayed through the display 512 and the information related to the luminance of the display 512, and obtain a fourth illuminance value through the light sensor 520 while the first image is displayed through the display 512, determine a fifth illuminance value based on color information about a second image different from the first image and the information related to the luminance of the display 512, and obtain a sixth illuminance value through the light sensor 520 while the second image is displayed through the display 512, and determine the correction value for correcting the illuminance value obtained through the light sensor 520, based on a first difference between the fifth illuminance value and the third illuminance value and a second difference between the sixth illuminance value and the fourth illuminance value.

In an embodiment, the instructions may, when executed by the at least one processor 540 individually or collectively, cause the electronic device 501 to determine the third illuminance value related to the light emitted from the display 512 while the display 512 displays an image by subtracting the second illuminance value from the first illuminance value.

In an embodiment, the instructions may, when executed by the at least one processor 540 individually or collectively, cause the electronic device 501 to determine, as the fourth illuminance value, a color on pixel ratio COPR illuminance value obtained based on COPR information about the image and a luminance code of the display 512.

In an embodiment, the instructions may, when executed by the at least one processor 540 individually or collectively, cause the electronic device 501 to perform determining the correction value based on the fourth illuminance value exceeding a second threshold illuminance value.

In an embodiment, the instructions may, when executed by the at least one processor 540 individually or collectively, cause the electronic device 501 to obtain a plurality of first correction values by performing, a designated number of times, obtaining the first illuminance value, obtaining the second illuminance value, obtaining the third illuminance value, determining the fourth illuminance value, and determining the correction value, and determine, as a final correction value, a maximum value among the plurality of first correction values.

In an embodiment, the instructions may, when executed by the at least one processor 540 individually or collectively, cause the electronic device 501 to determine whether the display 512 and/or the light sensor 520 is replaced, and perform obtaining the first illuminance value, obtaining the second illuminance value, obtaining the third illuminance value, determining the fourth illuminance value, and determining the correction value, based on determining that the display 512 and/or the light sensor 520 is replaced.

In an embodiment, a method for calibrating a light sensor 520 in an electronic device 501 may comprise obtaining a first illuminance value based on illuminance data obtained through the light sensor 520 for a first time while a display 512 of the electronic device 501 is turned on/off. The method may comprise obtaining a second illuminance value based on illuminance data obtained through the light sensor 520 at each second time shorter than the first time while the display 512 is turned on/off. The method may comprise determining a third illuminance value related to light emitted from the display 512, based on the first illuminance value and the second illuminance value. The method may comprise determining a fourth illuminance value based on color information about an image displayed through the display 512 and information related to a luminance of the display 512. The method may comprise determining a correction value for correcting an illuminance value obtained through the light sensor 520, based on the third illuminance value and the fourth illuminance value.

In an embodiment, obtaining the second illuminance value may include obtaining a plurality of illuminance values based on the illuminance data obtained through the light sensor 520 at each second time, and determining, as the second illuminance value, a minimum value among the plurality of illuminance values.

In an embodiment, determining the correction value may be performed based on the second illuminance value exceeding a first threshold illuminance value.

In an embodiment, the method may further comprise, based on the second illuminance value being equal to or less than a first threshold illuminance value determining a third illuminance value based on color information about a first image displayed through the display 512 and the information related to the luminance of the display 512, and obtain a fourth illuminance value through the light sensor 520 while the first image is displayed through the display 512, determining a fifth illuminance value based on color information about a second image different from the first image and the information related to the luminance of the display 512, and obtaining a sixth illuminance value through the light sensor 520 while the second image is displayed through the display 512, and determining the correction value for correcting the illuminance value obtained through the light sensor 520, based on a first difference between the fifth illuminance value and the third illuminance value and a second difference between the sixth illuminance value and the fourth illuminance value.

In an embodiment, determining the third illuminance value may include determining the third illuminance value related to the light emitted from the display 512 while the display 512 displays an image by subtracting the second illuminance value from the first illuminance value.

In an embodiment, determining the four illuminance value may include determining, as the fourth illuminance value, a COPR illuminance value obtained based on COPR information about the image and a luminance code of the display 512.

In an embodiment, determining the correction value may be performed based on the fourth illuminance value exceeding a second threshold illuminance value.

In an embodiment, the method may further comprise obtaining a plurality of first correction values by performing, a designated number of times, obtaining the first illuminance value, obtaining the second illuminance value, obtaining the third illuminance value, determining the fourth illuminance value, and determining the correction value, and determining, as a final correction value, a maximum value among the plurality of first correction values.

In an embodiment, the method may further comprise determining whether the display 512 and/or the light sensor 520 is replaced, and performing obtaining the first illuminance value, obtaining the second illuminance value, obtaining the third illuminance value, determining the fourth illuminance value, and determining the correction value, based on determining that the display 512 and/or the light sensor 520 is replaced.

An electronic device 501 according to an embodiment may comprise a display 512, a light sensor 520 disposed under at least a partial area of the display 512, at least one processor 540, and memory 530 storing instructions. The instructions may, when executed by the at least one processor 540 individually or collectively, cause the electronic device 501 to determine a first illuminance value based on color information about a first image and the information related to the luminance of the display 512 and obtain a second illuminance value through the light sensor 520 while the first image is displayed through the display 512. The instructions may, when executed by the at least one processor 540 individually or collectively, cause the electronic device 501 to determine a third illuminance value based on color information about a second image different from the first image and the information related to the luminance of the display 512 and obtaining a fourth illuminance value through the light sensor 520 while the second image is displayed through the display 512. The instructions may, when executed by the at least one processor 540 individually or collectively, cause the electronic device 501 to determine the correction value for correcting the illuminance value obtained through the light sensor 520, based on a first difference between the third illuminance value and the first illuminance value and a second difference between the fourth illuminance value and the second illuminance value.

In an embodiment, the instructions may, when executed by the at least one processor 540 individually or collectively, cause the electronic device 501 to determine the correction value by dividing the first difference by the second difference.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

In the present disclosure, the term “an embodiment” is not limited to a single embodiment, and may encompass one or more embodiments.

Further, the structure of the data used in embodiments of the disclosure may be recorded in a computer-readable recording medium via various means. The computer-readable recording medium includes a storage medium, such as a magnetic storage medium (e.g., a ROM, a floppy disc, or a hard disc) or an optical reading medium (e.g., a CD-ROM or a DVD).

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An electronic device comprising:
a display;
a light sensor;
at least one processor; and
memory storing instructions that, when executed by the at least one processor individually or collectively, cause the electronic device to:
obtain a first illuminance value based on illuminance data obtained through the light sensor for a first time during which the display is turned on and off,
obtain a second illuminance value based on illuminance data obtained through the light sensor for a second time shorter than the first time, while the display is turned on and off,
determine a third illuminance value based on the first illuminance value and the second illuminance value,
determine a fourth illuminance value based on color information about an image displayed through the display and information related to a luminance of the display, and
determine a correction value for correcting an illuminance value obtained through the light sensor based on the third illuminance value and the fourth illuminance value.

2. The electronic device of claim 1, wherein the instructions, when executed by the at least one processor individually or collectively, cause the electronic device to:
based on the illuminance data obtained at each second time, obtain a plurality of illuminance values, and
determine, as the second illuminance value, a minimum value among the plurality of illuminance values.

3. The electronic device of claim 1, wherein the instructions, when executed by the at least one processor individually or collectively, cause the electronic device to:
based on the second illuminance value exceeding a first threshold illuminance value, determine the correction value.

4. The electronic device of claim 3, wherein the instructions, when executed by the at least one processor individually or collectively, cause the electronic device to:
based on the second illuminance value being equal to or less than a first threshold illuminance value:
while a first image is displayed through the display, determine the third illuminance value based on color information about the first image and the information related to the luminance of the display, and obtain the fourth illuminance value through the light sensor,
while a second image different from the first image is displayed through the display, determine a fifth illuminance value based on color information about the second image and the information related to the luminance of the display, and obtain a sixth illuminance value through the light sensor, and
based on a first difference between the fifth illuminance value and the third illuminance value and a second difference between the sixth illuminance value and the fourth illuminance value, determine the correction value for correcting the illuminance value obtained through the light sensor.

5. The electronic device of claim 1, wherein the instructions, when executed by the at least one processor individually or collectively, cause the electronic device to:
obtain an illuminance difference value by subtracting the second illuminance value from the first illuminance value; and
determine the third illuminance value based on the illuminance difference value.

6. The electronic device of claim 1, wherein the instructions, when executed by the at least one processor individually or collectively, cause the electronic device to:
determine, as the fourth illuminance value, a color on pixel ratio (COPR) illuminance value obtained based on COPR information about the image and a luminance code of the display.

7. The electronic device of claim 6, wherein the instructions, when executed by the at least one processor individually or collectively, cause the electronic device to:
based on the fourth illuminance value exceeding a second threshold illuminance value, perform determining the correction value.

8. The electronic device of claim 1, wherein the instructions, when executed by the at least one processor individually or collectively, cause the electronic device to:
obtain a plurality of first correction values by repeatedly performing, a designated number of times, obtaining the first illuminance value, obtaining the second illuminance value, obtaining the third illuminance value, determining the fourth illuminance value, and determining the correction value, and
determine, as a final correction value, a maximum value among the plurality of first correction values.

9. The electronic device of claim 1, wherein the instructions, when executed by the at least one processor individually or collectively, cause the electronic device to:
determine whether at least one of the display or the light sensor is replaced, and
based on determining that the at least one of the display or the light sensor is replaced, obtain the first illuminance value, obtain the second illuminance value, obtain the third illuminance value, determine the fourth illuminance value, and determine the correction value.

10. A method for calibrating a light sensor in an electronic device, the method comprising:
obtaining a first illuminance value based on illuminance data obtained through the light sensor for a first time during which a display of the electronic device is turned on and off;
obtaining a second illuminance value based on illuminance data obtained through the light sensor for a second time shorter than the first time, while the display is turned on and off;
determining a third illuminance value based on the first illuminance value and the second illuminance value;
determining a fourth illuminance value based on color information about an image displayed through the display and information related to a luminance of the display; and
determining a correction value for correcting an illuminance value obtained through the light sensor based on the third illuminance value and the fourth illuminance value.

11. The method of claim 10, wherein obtaining the second illuminance value comprises:
based on the illuminance data obtained through the light sensor at each second time, obtaining a plurality of illuminance values; and
determining, as the second illuminance value, a minimum value among the plurality of illuminance values.

12. The method of claim 10, wherein determining the correction value is performed based on the second illuminance value exceeding a first threshold illuminance value.

13. The method of claim 12, further comprising:
based on the second illuminance value being equal to or less than a first threshold illuminance value:
while a first image is displayed through the display, determining the third illuminance value based on color information about the first image and the information related to the luminance of the display, and obtain the fourth illuminance value through the light sensor;
while a second image is displayed through the display, determining a fifth illuminance value based on color information about the second image and the information related to the luminance of the display, and obtaining a sixth illuminance value through the light sensor; and
based on a first difference between the fifth illuminance value and the third illuminance value and a second difference between the sixth illuminance value and the fourth illuminance value, determining the correction value for correcting the illuminance value obtained through the light sensor.

14. The method of claim 10, wherein determining the third illuminance value comprises:
obtaining an illuminance difference value by subtracting the second illuminance value from the first illuminance value; and
determining the third illuminance value based on the illuminance difference value.

15. The method of claim 10, wherein determining the fourth illuminance value comprises:
determining, as the fourth illuminance value, a color on pixel ratio (COPR) illuminance value obtained based on COPR information about the image and a luminance code of the display.

16. The method of claim 15, wherein determining the correction value is performed based on the fourth illuminance value exceeding a second threshold illuminance value.

17. The method of claim 10, further comprising:
obtaining a plurality of first correction values by repeatedly performing, a designated number of times, obtaining the first illuminance value, obtaining the second illuminance value, obtaining the third illuminance value, determining the fourth illuminance value, and determining the correction value; and
determining, as a final correction value, a maximum value among the plurality of first correction values.

18. The method of claim 10, further comprising:
determining whether at least one of the display or the light sensor is replaced; and
based on determining that the at least one of the display or the light sensor is replaced, obtaining the first illuminance value, obtaining the second illuminance value, obtaining the third illuminance value, determining the fourth illuminance value, and determining the correction value.

19. An electronic device comprising:
a display;
a light sensor;
at least one processor; and
memory storing instructions that, when executed by the at least one processor individually or collectively, cause the electronic device to:
while the first image is displayed through the display, determine a first illuminance value based on color information about a first image and information related to a luminance of the display and obtain a second illuminance value through the light sensor,
while a second image different from the first image is displayed through the display, determine a third illuminance value based on color information about the second image and information related to the luminance of the display and obtain a fourth illuminance value through the light sensor, and
determine a correction value for correcting the illuminance value obtained through the light sensor, based on a first difference between the third illuminance value and the first illuminance value and a second difference between the fourth illuminance value and the second illuminance value.

20. The electronic device of claim 19, wherein the instructions, when executed by the at least one processor individually or collectively, cause the electronic device to:
determine the correction value by dividing the first difference by the second difference.
